(19) United States
(12) Patent Application Publication
(10) Pub. No.: US 2007/0217015 A1
(43) Pub. Date: Sep. 20, 2007

(54) ANTIGLARE FILM, METHOD OF MANUFACTURING THE SAME, METHOD OF MANUFACTURING METAL MOLD THEREFOR, AND DISPLAY APPARATUS

(75) Inventors: Tsutomu Furuya, Niihama-shi (JP); Masato Kuwabara, Niihama-shi (JP)

Correspondence Address: FOLEY AND LARDNER LLP;SUITE 500, 3000 K STREET NW, WASHINGTON, DC, 20007, US

(73) Assignee: Sumitomo Chemical Company, Limited

(21) Appl. No.: 11/622,930

(22) Filed: Jan. 12, 2007

(30) Foreign Application Priority Data
Jan. 16, 2006 (JP) 2006-007048

(51) Int. Cl. G02B 5/08

(52) U.S. Cl. 359/602

(57) ABSTRACT

It is an object to provide an antiglare film which is excellent in an antiglare function and a visual confirmation, a method of manufacturing the antiglare film, and a method of manufacturing a metal mold for obtaining the antiglare film, and the antiglare film is applied to an image display apparatus. In the antiglare film, a fine concavo-convex portion is formed on a transparent base material, an average length PSm in a sectional curve of the concavo-convex surface is not greater than 12 μm, a ratio Pa/PSm of an arithmetic average height Pa in the sectional curve to the average length PSm is from 0.005 to 0.012, a rate of a plane having the concavo-convex surface in an inclination angle of 2 degrees or less is not higher than 50%, and a rate of a plane having the concavo-convex surface in an inclination angle of 6 degrees or less is not lower than 90%.

### FIELD OF THE INVENTION

The present invention relates to an antiglare film having a low haze and an excellent antiglare characteristic, a method of manufacturing the antiglare film, a method of manufacturing a metal mold used for manufacturing the antiglare film, and an image display apparatus comprising the antiglare film.

### BACKGROUND OF THE INVENTION

In an image display apparatus such as a liquid crystal display, a plasma display panel, a cathode-ray tube (CRT) display or an organic electroluminescence (EL) display, a visual confirmation is remarkably deteriorated when an external light is projected into a display plane thereof. In order to prevent the projection of the external light, conventionally, a film preventing the projection of the external light has been provided on a surface of the display of a television and a personal computer of which picture quality is regarded as important, a video camera and a digital camera which are used outdoors with a strong sunlight, and a cellular phone with a display displaying image by reflecting light. A kind of the film is roughly divided into two; one is a film treated with a non-reflecting treatment utilizing an interference through an optical multilayer film, the other is a film treated with an antiglare treatment for scattering an incident light to shade off a projected image by forming very fine concavo-convex portions on its surface. In the former non-reflecting film, it is necessary to form a multilayer film having a uniform optical film thickness. For this reason, a cost is increased. On the other hand, since the latter antiglare film can be manufactured comparatively inexpensively, it can widely be used in large-sized personal computers and monitors.

Such an antiglare film has conventionally been manufactured by a method of coating a base sheet with a resin solution having a filler dispersed therein and regulating a thickness of a coated film to expose the filler to a surface of the coated film, thereby forming random concave-convex portions on the surface of a sheet or the like, for example. In the antiglare film manufactured by dispersing the filler, however, the arrangement and shape of the concavo-convex portions depend on the dispersing and coating states of the filler in the resin solution and the like. For this reason, it is not easy to obtain the concavo-convex portions as intended and a sufficient antiglare performance cannot be achieved by one with a low haze. In the case in which the conventional antiglare film is disposed on the surface of the image display, furthermore, the whole display plane becomes whitish by the scattered light and a display becomes blurred, that is, so-called discoloring is apt to be generated. Moreover, a pixel of the image display apparatus and the concavo-convex shape of the surface of the antiglare film interfere with each other with a recent increase in the precision of the image display apparatus so that a luminance distribution is generated to see a display with difficulty, that is, a so-called dazzling phenomenon is generated easily.

On the other hand, there is also a trial for revealing an antiglare property by only fine concavo-convex portions formed on a surface of a transparent resin layer without containing a filler. For example, JP No. 2002-189106 A (refer to claims 1 to 6 and Paragraphs 0043 to 0046) has disclosed an antiglare film in which an ionizing radiation curing resin is interposed between an emboss mold and a transparent resin film and is cured in this state, and such fine concavo-convex portions that a three-dimensional 10-point average roughness and an average distance between adjacent convex portions on a three-dimensional roughness reference plane satisfy predetermined values respectively are thus formed and the ionizing radiation curing resin layer having the concavo-convex portions formed thereon are provided on the transparent resin film.

Moreover, JP No. 6-34961 A (refer to claims 1 to 3 and Paragraph 0024), JP No. 2004-45471 A (refer to claim 4 and Example 1) and JP No. 2004-45472 A (refer to claim 4 and Example 1) and the like have disclosed the use of a film having fine concavo-convex portions formed on a surface as a light diffusing layer to be disposed on a back side of a liquid crystal display in place of the antiglare film to be disposed on a display plane of the display apparatus, for example.

As a technique for forming the concavo-convex portions on the surface of the film, JP No. 2004-45471 A and JP 2004-45472 A have disclosed a method of filling an ionizing radiation curing resin solution in an emboss roll having a shape obtained by inverting the concavo-convex portions of a film to be produced, causing a transparent base material running synchronously with a rotating direction of a roll Intaglio to come in contact with the filled resin, curing the resin between the roll intaglio and the transparent base material when the transparent base material is maintained in contact with the roll intaglio, causing the curing resin and the transparent base material to adhere to each other simultaneously with the curing, and then peeling a laminated product of the resin and the transparent base material after the curing from the roll intaglio.

In such a technique, a composition of the ionizing radiation curing resin solution which can be used is limited and it is not easy to expect leveling obtained when carrying out a dilution with a solvent and coating. For this reason, it is supposed that a uniformity of a film thickness has a problem. Furthermore, it is necessary to directly fill the emboss roll intaglio with the resin solution. In order to ensure the uniformity of the concavo-convex surface, therefore, high mechanical precision is required for the emboss roll intaglio. Thus, it is hard to fabricate the emboss roll.

As a method of fabricating a roll which is to be used for fabricating a film having concavo-convex portions on a surface, for example, JP No. 6-34961 A has disclosed a method of making a. cylinder by using a metal and forming concavo-convex portions on a surface thereof through a technique such as electronic engraving, etching or sand blast. Moreover, JP No. 2004-29240 A (refer to claim 2) has disclosed a method of fabricating an emboss roll by a bead shot method, and JP No. 2004-90187 A (refer to claims 1 and 2) has disclosed a method of fabricating an emboss roll through a step of forming a metal plated layer on a surface of the emboss roll, a step of mirror polishing a surface of the metal plated layer, a step of carrying out a blast treatment over the metal plated layer surface subjected to the mirror polishing by using ceramic beads, and furthermore, a step of executing a blast treatment if necessary.

In a state in which the blast treatment is maintained to be carried out over the surface of the emboss roll, thus, a distribution of a concavo-convex diameter is caused by a distribution of a particles size of a blast particle, and furthermore, it is hard to control a depth of a dent obtained by the blasting. Therefore, it is not easy to obtain the shape of the concavo-convex portion having an excellent antiglare function with a high reproducibility.

Moreover, JP No. 2002-189106 Ahas described that a roller obtained by plating an iron surface with chromium is preferably used to form a concavo-convex mold surface by a sandblast method or a bead shot method. Furthermore, JP No. 2002-189106 A also has described that it is preferable to use the mold surface having the concavo-convex portions formed thereon which is subjected to the chromium plating in order to enhance a durability in the use and it is possible to prevent a film from being hardened and a corrosion from being caused. On the other hand, examples of JP No. 2004-45471 A and JP No. 2004-45472 A have described that a surface of an iron core is plated with chromium and a #250 liquid sand blast treatment is carried out, and the chromium plating treatment is then performed again to form fine concavo-convex shapes on a surface.

In the method of fabricating the emboss roll, blast and shot are carried out over the chromium plating having a high hardness. For this reason, the concavo-convex portion is formed with difficulty, and furthermore, it is not easy to precisely control the shape of the concavo-convex portion which is formed. As described In JP No. 2004-29672 A (refer to Paragraph 0030), moreover, the chromium plating often causes a surface to be rough depending on a material and a shape of an undercoat, and a fine crack is generated by the chromium plating over the concavo-convex portions provided by the blast. For this reason, a design is not easy to perform depending on any concavo-convex portion which is formed. Furthermore, the fine crack is generated by the chromium plating. Therefore, the scattering characteristic of the antiglare film obtained finally may be changed to a non-preferable direction. By a combination of metal species and plating species on the surface of an emboss roll base material, furthermore, a finished roll surface is variously changed. For this reason, proper metal species of the roll surface and proper plating species are to be selected in order to obtain the necessary surface concavo-convex shape with high precision. Even if a desirable surface concavo-convex shape is obtained, moreover, a durability in use becomes insufficient depending on the plating species in some cases.

On the other hand, JP No. 2005-92197 A (refer to claim 1 and Paragraph 0031) made by the present inventors has disclosed an antiglare film in which a rate of a plane having concavo-convex surfaces in an inclination angle of 1 degree or less is equal to or lower than 20% and a rate of a plane having the surface in an inclination angle of 5 degrees or more is equal to or lower than 20%, and a standard deviation of a height is equal to or smaller than 0.2 μm. Similarly, JP No. 2005-140890 A (refer to claim 1 and Paragraph 0056) has disclosed an antiglare film in which a higher region than an average height of concavo-convex portions is set to be a convex and a lower region than an average height of concavo-convex portions is set to be a concave, and a peak position and a half-value width thereof satisfy predetermined conditions in the case in which a frequency of an apparent area obtained from an projection area of each of the convex and the concave is expressed in a histogram. When the haze is high, a front contrast is reduced when a liquid crystal display is constituted by a combination of the antiglare film and the liquid crystal panel. For this reason, the haze is preferably equal to or lower than 10% in the former publication and is preferably equal to or lower than 15% in the latter publication.

### SUMMARY OF THE INVENTION

It is an object of the present invention to provide an antiglare film which sufficiently prevents a reduction in a visual confirmation due to discoloring while exhibiting an excellent antiglare function, and does not generate a dazzle when it is disposed on a surface of an image display apparatus with high precision, a method of manufacturing the antiglare film, and a method of manufacturing a metal mold for obtaining the antiglare film, and furthermore, to provide an image display apparatus to which the antiglare film is applied. Moreover, it is an object of the present invention to employ chromium plating which is excellent in a hardness and a surface gross as plating over a surface of a metal mold to manufacture a suitable metal mold for fabricating the antiglare film without generating a roughness on the chromium plated surface and to manufacture the antiglare film exhibiting an excellent antiglare function by using the metal mold.

In order to achieve the objects, the present inventors repetitively made studies eagerly. As a result, they found that an antiglare film having a concavo-convex surface which is obtained by carrying out copper plating or nickel plating as undercoat plating over a surface of a metal to be a metal mold, hitting fine particles onto the plated surface to form concavo-convex portions, performing chromium plating on the concavo-convex surface to form the metal mold, and transferring the concavo-convex surface of the metal mold onto a transparent resin film with a low haze and a sufficient antiglare performance, and generates neither discoloring nor dazzling also when it is disposed in the image display apparatus but exhibits an excellent visual confirmation. That is, a performance which is not possessed by the conventional products is achieved. Moreover, it was found that a negative metal mold for obtaining a film to satisfy the optical characteristic can be obtained with a high reproducibility by using a surface coated by specific metal plating as described above to form a metal mold having a surface having concavo-convex portions through steps. The present invention has been completed by making various investigations based on the knowledge.

More specifically, the antiglare film according to the present invention has a fine concavo-convex portion formed on a transparent base material, an average length PSm in an optional sectional curve of the concavo-convex surface is not more than 12 μm, a ratio Pa/PSm of an arithmetic average height Pa in the sectional curve to the average length PSm is from 0.005 to 0.012, a rate of a plane having the concavo-convex surface in an inclination angle of 2 degrees or less is not higher than 50%, and a rate of a plane having the concavo-convex surface in an inclination angle of 6 degrees or less is not lower than 90%.

In the present invention, even if the antiglare layer does not contain fine particles, it is possible to achieve the concavo-convex shapes of the surface. In the antiglare film, it is preferable that an average area of a polygon formed when an apex of a convex portion of the concavo-convex surface is set to be a generating point and the surface is voronoi divided should not be smaller than 100 μm² and should not be larger than 200 μm². In the antiglare film, moreover, it is preferable that a haze should not be higher than 12%, a total of reflection visibilities measured at an incident angle of 45 degrees by using three types of optical combs having widths between dark and bright portions of 0.5 mm, 1.0 mm and 2.0 mm should not be larger than 50%, and furthermore, with respect to a light incident at an incident angle of 30 degrees, it is preferable that a reflectance R(30) of a reflecting angle of 30 degrees should not be lower than 0.05% and should not be higher than 1.5% and a reflectance R(50) of a reflecting angle of 50 degrees should not be lower than 0.00001% and should not be higher than 0.0003%.

The antiglare film is advantageously manufactured by a method comprising the steps of carrying out copper plating or nickel plating over a surface of a metal, polishing the plated surface, hitting a fine particle onto the polished surface to form a concavo-convex portion, carrying out chromium plating over the concavo-convex surface to form a metal mold, transferring the concavo-convex surface of the metal mold onto a transparent resin film, and peeling, from the metal mold, the transparent resin film having the concavo-convex portion transferred thereto.

In the method, it is advantageous that the surface is not polished after the chromium plating and the chromium plated surface is exactly used as the concavo-convex surface of the metal mold. It is preferable that a chromium plating thickness should not be smaller than 1 μm and should not be greater than 20 μm, and furthermore, should not be smaller than 3 μm and should not be greater than 10 μm. The transparent resin film to which the concavo-convex surface of the metal mold is to be transferred is constituted by the surface of the transparent base film on which the photocuring resin layer is formed, and the photocuring resin layer is pushed against the concavo-convex surface of the metal mold and is thus cured. Consequently, it is possible to transfer the concavo-convex surface of the metal mold onto the photocuring resin layer.

According to the present invention, moreover, there is also provided a method comprising the steps of carrying out copper plating or nickel plating over a surface of a metal, polishing the plated surface, hitting a particle onto the polished surface to form a concavo-convex portion, and carrying out chromium plating over the concavo-convex surface, thereby manufacturing a metal mold for fabricating an antiglare film.

### BRIEF DESCRIPTION OF THE DRAWINGS

FIG. 1 is a perspective view schematically showing a surface of an antiglare film and explaining an inclination angle of a surface,

FIG. 2 is a typical perspective view for explaining a method of measuring the inclination angle of the surface,

FIG. 3 is a chart showing an example of a graph representing a histogram of the inclination angle of the surface of the antiglare film,

FIG. 4 is a perspective view typically showing an algorithm of a decision of a convex portion in the antiglare film,

FIG. 5 is a voronoi diagram showing an example in which a voronoi division is carried out by setting an apex of the convex portion of the antiglare film to be a generating point,

FIG. 6 is a perspective view typically showing a direction of incidence of a light on the antiglare film and a direction of reflection,

FIG. 7 is a chart showing an example of a graph in which a reflection angle of a reflected light for a light which is incident at an angle of 30 degrees from a normal of the antiglare film and a reflectance (the reflectance is a logarithmic scale) is plotted,

FIG. 8 is a plan view showing a unit cell of a pattern for a dazzle evaluation,

FIG. 9 is a typical sectional view showing a state of the dazzle evaluation,

FIG. 10 is a typical sectional view showing steps of a method of manufacturing an antiglare film according to the present invention,

FIG. 11 is a typical sectional view showing a state in which a surface is polished after chromium plating,

FIG. 12 is a graph representing a histogram of a surface inclination angle of an antiglare film obtained in examples 1 to 3,

FIG. 13 is a graph representing a reflecting profile of the antiglare film obtained in the examples 1 to 3.

FIG. 14 is a graph representing a histogram of a surface inclination angle of an antiglare film obtained in comparative examples 1 and 2,

FIG. 15 is a graph representing a reflecting profile of the antiglare film obtained in the comparative examples 1 and 2,

FIG. 16 is a graph representing a histogram of a surface inclination angle of an antiglare film obtained in a comparative example 3,

FIG. 17 is a graph representing a reflecting profile of the antiglare film obtained in the comparative example 3,

FIG. 18 is a graph representing a histogram of a surface inclination angle of an antiglare film obtained in a comparative example 4,

FIG. 19 is a graph representing a reflecting profile of the antiglare film obtained in the comparative example 4,

FIG. 20 is a graph representing a histogram of a surface inclination angle for an antiglare film according to comparative examples 5 to 10, and

FIG. 21 is a graph representing a reflecting profile for the antiglare film according to the comparative examples 5 to 10.

### DETAILED DESCRIPTION OF THE PREFERRED EMBODIMENTS

A preferred embodiment of the present invention will be described below in detail. In an antiglare film according to the present invention, fine concavo-convex portions are formed on a surfaces an average length PSm in an optional sectional curve on a concavo-convex surface is not larger than 12 μm, a ratio Pa/PSm of an arithmetic average height Pa in the sectional curve to the average length PSm is from 0.005 to 0.012, a rate of a plane having a concavo-convex surface in an inclination angle of 2 degrees or less is not larger than 50%, and a rate of a plane having an inclination angle of 6 degrees or less is not lower than 90%. In the present invention, the containment of a fine particle (filler) in the antiglare layer is not necessary eliminated but such a surface shape or an optical characteristic can be achieved even if the particle is not contained in the antiglare layer.

In the case in which the average length PSm of the concavo-convex portion is greater than 12 μm, a pixel of a recent image display apparatus with high precision and a surface concavo-convex shape of the antiglare film interfere with each other so that a dazzle is easily generated when the antiglare film is disposed in the image display apparatus. Although a lower limit of the average length PSm of the concavo-convex portion is not particularly restricted, it is generally preferable that the average length PSm should be not smaller than 1 μm.

If the ratio Pa/PSm of the arithmetic average height Pa to the average length PSm is lower than 0.005 or a rate of a plane having a concavo-convex surface in an inclination angle of 2 degrees is higher than 50%, moreover, the concavo-convex surface is nearly flat so that a sufficient antiglare performance cannot be obtained and an image of a light source or the like glares easily. On the other hand, if the ratio Pa/PSm is higher than 0.012 or a rate of a plane having a concavo-convex surface in an inclination angle of 6 degrees is lower than 90%, the inclination angle of the concavo-convex surface becomes very great so that a light emitted from a periphery is collected and discoloring causing a display plane to be wholly white is apt to be generated. The lower rate of the plane having an inclination angle of 2 degrees or less is preferable and, for example, a rate of 40% or less is more preferable. For example, a top portion of the convex and a bottom portion of the concave actually have an inclination angle of zero degree. For this reason, the rate of the plane having an inclination angle of 2 degrees or less can be prevented from being zero.

Further description will be given to a surface roughness, that is, the average length PSm in the optional sectional curve of the concavo-convex surface and the arithmetic average height Pa. These have values determined based on JIS B 0601. The former average length PSm is also referred to as an average interval of the concavo-convex portion and the latter arithmetic average height Pa is also referred to as a central line average roughness or an arithmetic average roughness. In a measurement of the surface roughness, there is a limit if a conventional general contact type surface roughness meter is used. Moreover, there is a possibility that the antiglare film might be damaged to cause an Impossible quantitative measurement. Therefore, it is preferable that three-dimensional information about the concavo-convex shape of the surface should be acquired by an apparatus such as a confocal microscope, an interference microscope or an atomic force microscope (AFM) and the surface roughness should be determined based on the information. In the case in which the surface roughness is calculated from the three-dimensional information, it is preferable that a region of 200 μm×200 μm or more should be measured on three points or more and a measured value should be set with an average value thereof in order to maintain a sufficient reference length.

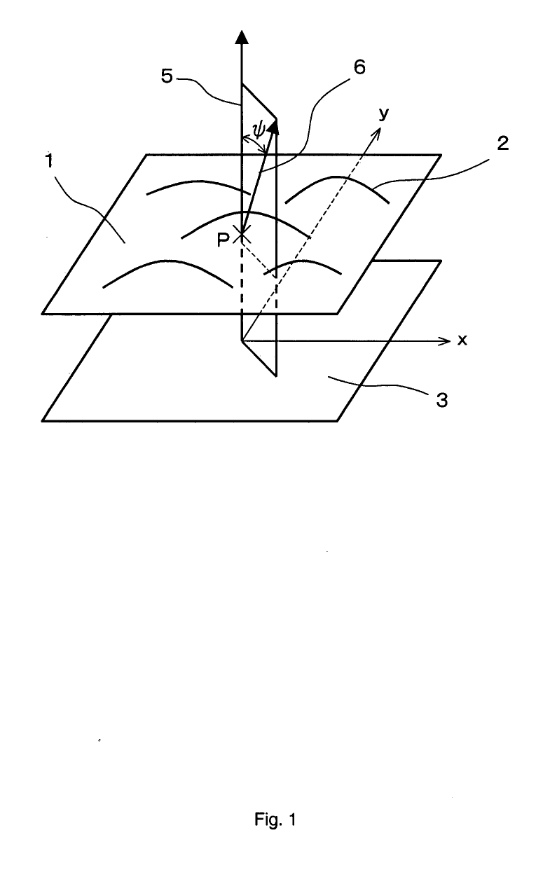

Next, description will be given to the inclination angle of the surface of the antiglare film. FIG. 1 is a perspective view schematically showing the surface of the antiglare film. With reference to FIG. 1, an antiglare film 1 has a fine concavo-convex portion formed on a surface thereof. An inclination angle of the concavo-convex surface in the present invention indicates an angle ψ formed by a local normal 6 to which a concavo-convex portion therein is added with respect to a main normal 5 of the film, that is, a normal on an average surface of the film 1 at an optional point P on the surface of the film 1. In FIG. 1, Cartesian coordinates in the film plane are represented as (x, y), and furthermore, a plane of the whole film is illustrated as a projecting surface 3.

The inclination angle of the surface of the film can be obtained from the three-dimensional information about the surface roughness measured by the apparatus such as the confocal microscope, the interference microscope or the atomic force microscope (AFM). A horizontal resolution required for a measuring machine is at least equal to or lower than 5 μm and is preferably not higher than 2 μm, and a vertical resolution is at least equal to or lower than 0.1 μm and is preferably not higher than 0.01 μm. Examples of a non-contact three-dimensional surface shape and roughness measuring machine which is suitable for the measurement can include “New View 5000” series which is manufactured by Zygo Corporation in USA and is available from Zygo Corporation in Japan, a confocal microscope “PLμ2300” manufactured by Sensofar Co., Ltd. and the like. A larger measured area is preferable. It is preferable that the measured area should be set to be at least 200 μm×200 μm. It is preferable that a region of 200 μm×200 μm or more should be measured on three points or more and an average value thereof should be set to be a measured value.

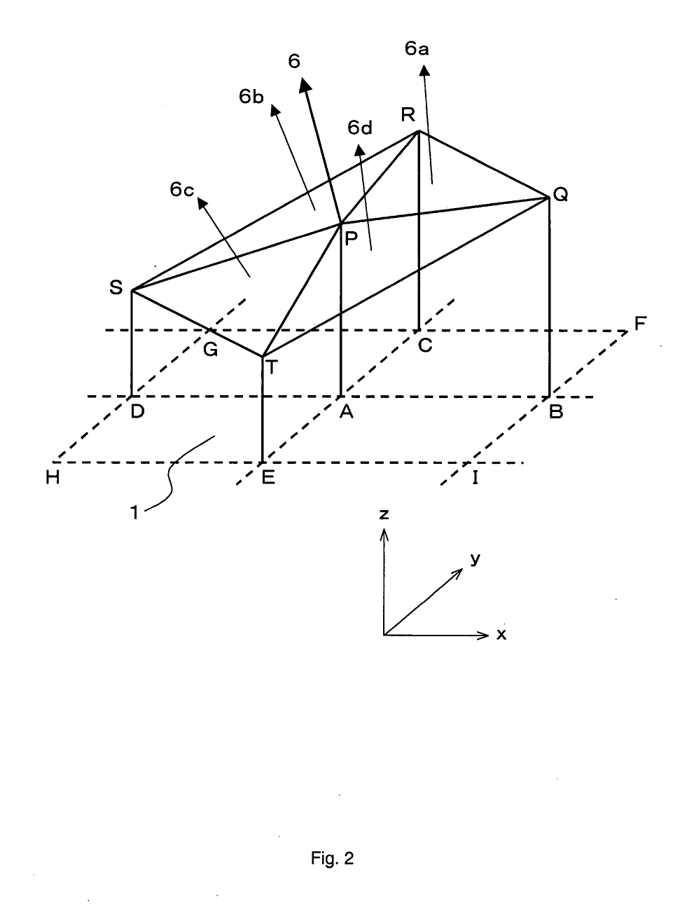

Description will be given to a specific method of determining an inclination angle. As shown in FIG. 2, a noted point A on a film average plane FGHI shown in a dotted line is determined, points B and D are taken almost symmetrically with the point A in the vicinity of the point A on an x axis passing therethrough, and points C and F are taken almost symmetrically with the point A in the vicinity of the point A on a y axis passing through the point A. Thus, points Q, R. S and T on the film plane corresponding to the points B, C, D and B are determined. In FIG. 2, the Cartesian coordinates (x, y) in the film plane are expressed in (x, y) and coordinates in a direction of a thickness of the film is expressed in z. The film average plane FGHI is formed by respective intersection points F, G, H and I with a straight line which is parallel with the x axis passing through the point C on the y axis, a straight line which is parallel with the x axis passing through the point E on the y axis, a straight line which is parallel with the y axis passing through the point B on the x axis, and a straight line which is parallel with the y axis passing through the point D on the x axis, and the film average plane is necessarily constituted. In FIG. 2, moreover, an actual position of the film plane is drawn above the film average plane FGHI. It is a matter of course that the actual position of the film plane is placed above or below the film average plane depending on the position of the point A.

An inclination angle of surface shape data can be obtained by acquiring a polar angle of an average normal vector 6 calculated by averaging normal vectors 6a, 6b, 6c and 6d of four polygon planes formed by five points in total including the point P on the actual film plane corresponding to the point A and points Q, R, S and T on the actual film plane corresponding to the four points B, C, D and E taken in the vicinity thereof, that is, four triangles PQR, PRS, PST and PTO. After an inclination angle is obtained for each measuring point, a histogram is calculated.

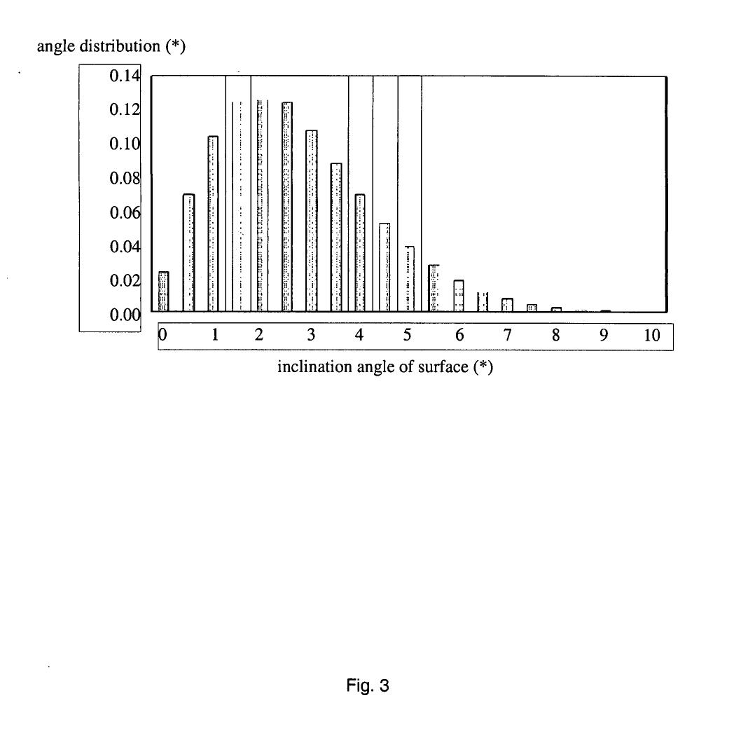

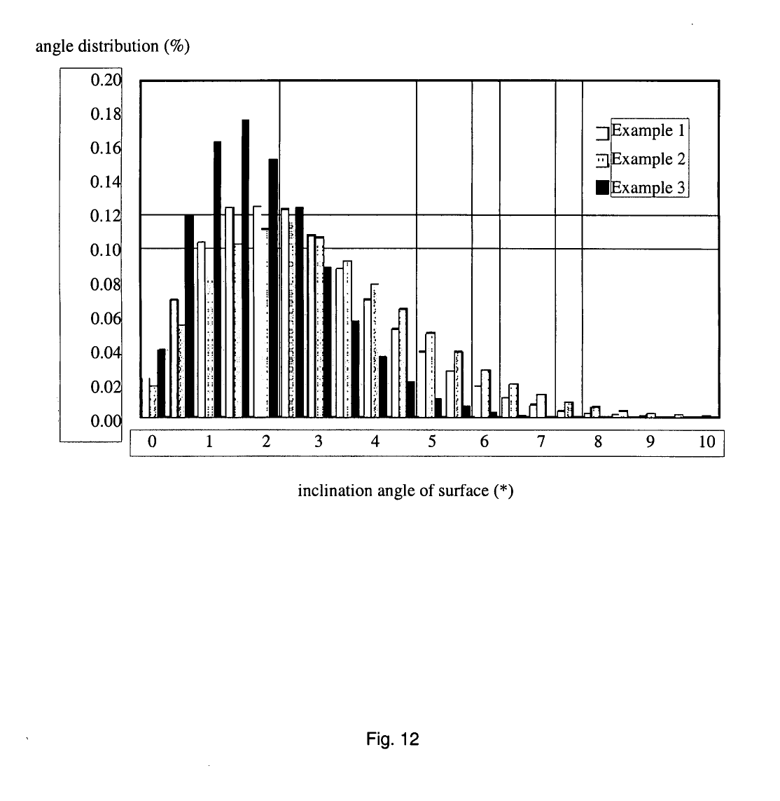

FIG. 3 shows an example of a histogram of an inclination angle distribution. In FIG. 3, an axis of abscissas indicates an inclination angle which is divided at an interval of 0.5 degree. For example, a leftmost longitudinal bar indicates a distribution of a group in which the inclination angle is 0 to 0.5 degree, and the angle is gradually increased by 0.5 degrees in a rightward direction. In FIG. 3, a lower limit value is displayed every two scales of the axis of abscissas and, for example, a portion with “1” in the axis of abscissas indicates a distribution of a group in which the inclination angle is 1 to 1.5 degrees. Moreover, an axis of ordinates indicates a distribution of the inclination angle which has a value to be 1 through an integration. In this example, a rate of a plane having an inclination angle of 2 degrees of less is approximately 32% and a rate of a plane having an inclination angle of 6 degrees or less is approximately 95%. In FIGS. 12, 14, 16, 18 and 20 showing a histogram according to examples and comparative examples which will be described below, the way of a display is the same as that in FIG. 3.

According to the investigations of the present inventors, antiglare films which are currently put on the market do not completely satisfy the requirements that the average length PSm in the optional sectional curve of the concavo-convex surface is not larger 12 μm, the ratio Pa/PSm of the arithmetic average height Pa in the sectional curve to the average length PSm is from 0.005 to 0.012, a rate of a plane having a concavo-convex surface in an inclination angle of 2 degrees or less is not higher than 50%, and a rate of a plane having an inclination angle of 6 degrees or less is not lower than 90%. As a result, there has not been an antiglare film having all of performances, that is, a low haze, a sufficient prevention of a glare, a suppression of discoloring, and a prevention of a dazzle.

In the antiglare film according to the present invention, moreover, it is preferable that an average area of a polygon formed by voronoi dividing the concavo-convex surface with an apex of a convex portion in the surface to be a generating point should be from 100 μm² to 200 μm².

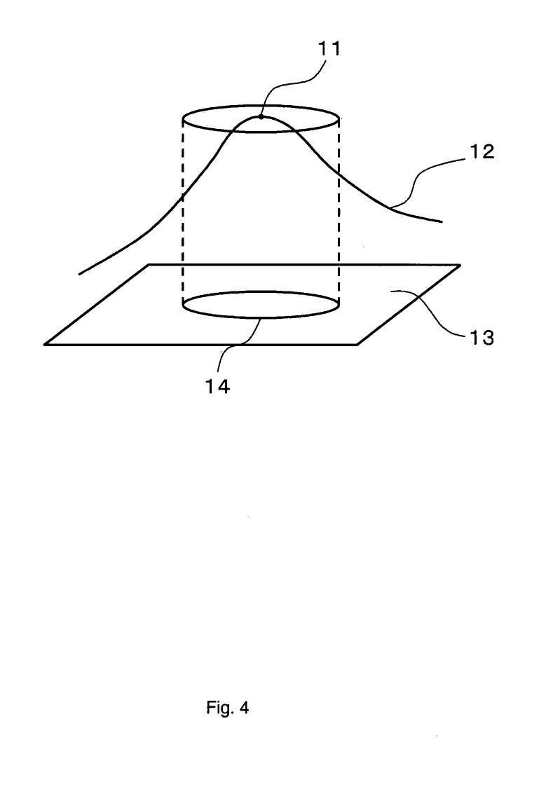

First of all, description will be given to an algorithm for obtaining the apex of the convex portion in the concavo-convex surface of the antiglare film. When an optional point on the surface of the antiglare film is noted, the point is set to be the apex of the convex portion in the case in which there is no point having a higher elevation than the noted point around the point and an elevation on the concavo-convex surface at that point is higher than a middle of an elevation of the highest point of the concavo-convex surface and that of the lowest point. More specifically, as shown in FIG. 4, when an optional point 11 on the surface of the antiglare film is noted and a circle having a radius of 2 to 5 μm which is parallel with an antiglare film reference plane 13 is drawn around the noted point 11, the point 11 is decided to be the apex of the convex portion in the case in which there is no point having a higher elevation than the noted point 11 in points on the antiglare film surface 12 contained in a projecting plane 14 of the circle and an elevation of a concavo-convex surface on the point is higher than a middle of an elevation of the highest point of the concavo-convex surface and that of the lowest point. In that case, the radius of the circle 14 is required in such a manner that fine concavo-convex portions on a sample surface are not counted and a plurality of convex portions is not included, and is preferably approximately 3 μm. According to the technique, it is also possible to determine the number of the convex portions per unit area of the concavo-convex surface.

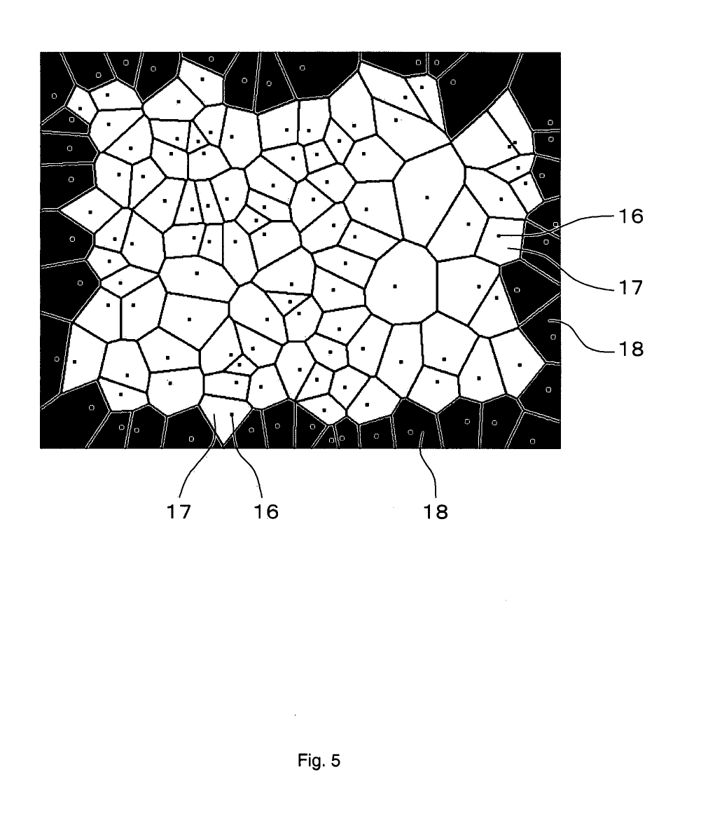

Next, the voronoi division will be described. When some points (referred to as generating points) are disposed on a plane, a diagram which can be formed by dividing the plane depending on any of the generating points to which an optional one of the points in the plane is the closest is referred to as a voronoi diagram, and the division is referred to as a voronoi division. FIG. 5 shows an example in which an apex of a convex portion on a surface of an antiglare film is set to be a generating point and the surface is subjected to the voronoi division. In FIG. 5, square points 16 and 16 are the generating points and individual polygons 17 and 17 including one generating point are regions formed by the voronoi division which are referred to as voronoi regions or voronoi polygons, and will be hereinafter referred to as voronoi polygons. In FIG. 5, surrounding portions 18 and 18 painted thinly on a periphery will be described later. In the voronoi diagram, the number of generating points is coincident with that of the voronoi polygons. In FIG. 5, a leading line and a designation are attached to only a part of the generating points and the voronoi polygon. From the above description and FIG. 5, it can easily be understood that a large number of generating points and voronoi polygons are present.

In order to obtain an average area of the voronoi polygon obtained by carrying out the voronoi division with an apex of a convex portion to be the generating point, a surface shape is measured by an apparatus such as a confocal microscope, an interference microscope or an atomic force microscope (AFM), three-dimensional coordinate values on each point on the surface of the antiglare film are obtained, the voronoi division is then carried out in accordance with the following algorithm, and an average area of the voronoi polygon is thus obtained. More specifically, the apex of the convex portion on the concavo-convex surface of the antiglare film is first obtained in accordance with the algorithm, and then, the apex of the convex portion is projected onto the antiglare film reference plane. Thereafter, all of the three-dimensional coordinates obtained by measuring the surface shape are projected onto the reference plane, and all of the points thus projected are caused to belong to the nearest generating point, thereby carrying out the voronoi division. An area of each polygon obtained by the division is calculated and averaged, and an average area of the voronoi polygon is thus obtained. In a measurement, the voronoi polygon coming in contact with a boundary of a measuring visual field is not calculated in order to decrease an error. More specifically, in FIG. 5, the voronoi polygons 18 and 18 painted thinly in contact with the boundary of the visual field are not counted for calculating the average area. In order to lessen a measuring error, moreover, it is preferable that regions of 200 μm×200 μm or more should be measured on three points or more and an average value thereof should be set to be a measured value.

In the present invention, as described above, it is preferable that an average area of the polygon formed by setting the apex of the convex portion in the concavo-convex surface to be the generating point and carrying out the voronoi division over the surface should not be smaller than 100 μm² and not be greater than 200 μm². In the case in which the average area of the voronoi polygon is smaller than 100 μm², an inclination angle of the surface of the antiglare film is considerably increased. As a result, discoloring is generated easily, which is not preferable. On the other hand, in the case in which the average area of the voronoi polygon is greater than 200 μm², the shape of the concavo-convex surface becomes rough. In an application to a recent image display apparatus with high precision, a dazzle is apt to be generated, and furthermore, a texture is also deteriorated, which is not preferable.

In the antiglare film according to the present invention, furthermore, it is preferable that the haze should not be higher than 12%, a total of a reflecting visibility measured at a light incident angle of 45 degrees by using three types of optical combs having widths between dark and bright portions which are 0.5 mm. 1.0 mm and 2.0 mm should not be higher than 100%, and particularly, not be higher than 50%, and furthermore, a reflectance R(30) of a reflecting angle of 30 degrees should be from 0.05% to 1.5% with respect to a light incident at an incident angle of 30 degrees, and a reflectance R(50) at a reflecting angle of 50 degrees should be from 0.00001% to 0.0003%.

The haze is measured by a method specified by JIS K 7136. When the haze exceeds 12%, an image becomes dark when the antiglare film is disposed in the image display apparatus. As a result, a front contrast is easily reduced, which is not preferable in use.

The reflecting visibility is measured by a method specified by JIS K 7105. In the standards, four types of optical combs to be used for measuring an image visibility are specified in a ratio of the widths of the dark and bright portions of 1 to 1 and widths of 0.125 mm, 0.5 mm, 1.0 mm and 2.0 mm. In the case in which the optical comb having the width of 0.125 mm is used, an error of a measured value is increased in the antiglare film specified by the present invention. For this reason, it is assumed that the measured value obtained by using the optical comb having the width of 0.125 mm is not added to a sum and a sum of image visibilities measured by using three types of optical combs having the widths of 0.5 mm, 1.0 mm and 2.0 mm will be referred to as a reflecting visibility. The reflecting visibility based on the definition has a maximum value of 300%. When the reflecting visibility based on the definition is excessively increased, an image of a light source or the like glares so that the antiglare property tends to be deteriorated easily.

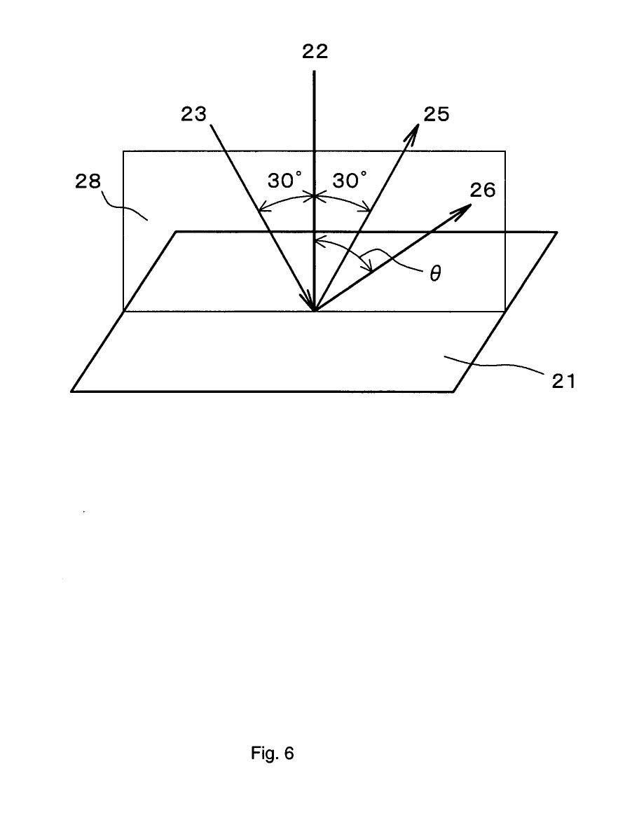

Next, description will be given to a reflectance at a predetermined reflecting angle with respect to a light incident at an incident angle of 30 degrees. FIG. 6 is a perspective view typically showing the directions of incidence and reflection of a light with respect to the antiglare film. In the present invention, when a reflectance of a reflected light (that is, a regular reflectance) in a direction at a reflecting angle of 30 degrees, that is, in a regular reflecting direction 25 is set to be R(30) with respect to an incident light 23 at an angle of 30 degrees from a normal 22 of an antiglare film 21, it is preferable that R(30) should be from 0.05% to 1.5%. When the regular reflectance R(30) is lower than 0.05%, a reflectance on a high angle side is increased so that discoloring tends to be generated easily. When R(30) exceeds 1.5%, moreover, a sufficient antiglare function cannot be obtained and a visual confirmation tends to be reduced. In FIG. 6, a light reflected at an optional reflecting angle θ is represented as 26, and directions 25 and 26 of the reflected light in a measurement of the reflectance are assumed to be included in a plane 28 containing the direction 23 of the incident light and the normal 22.

In the present invention, when a reflectance at a reflecting angle of 50 degrees is set to be R(50) with respect to the incident light 23 at an angle of 30 degrees from the normal 22 of the antiglare film 21 in FIG. 6, it is preferable that R(50) should be from 0.00001% to 0.0003%. In the case in which R(50) is lower than 0.00001%, a glare with which a contour of the light source or the like can be recognized over the antiglare film is observed and an antiglare function tends to be deteriorated. On the other hand, when R(50) exceeds 0.0003%, the glare is caused with difficulty and the discoloring tends to be generated easily. More specifically, also in the case in which black is displayed on a display plane in a state in which the antiglare film is disposed on a foremost surface of the display apparatus, for example, there is a tendency to easily generate the discoloring in which the display plane wholly becomes whitish by picking up a light from a periphery.

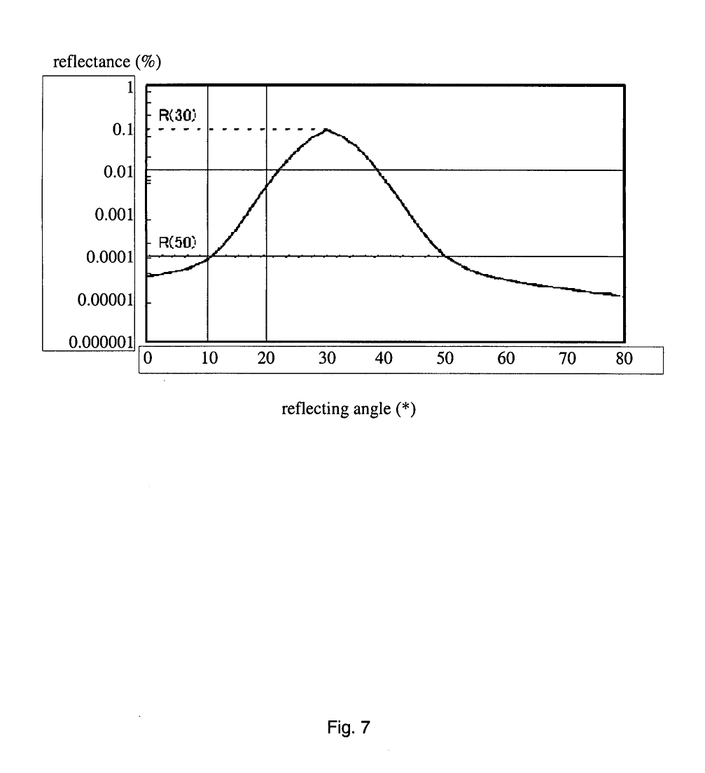

FIG. 7 shows an example of a graph in which there are plotted a reflecting angle and a reflectance (the reflectance is indicated as a logarithmic scale) of a reflected light 26 for the incident light 23 at the angle of 30 degrees from the normal 22 of the antiglare film 21 in FIG. 6. A graph representing a relationship between the reflecting angle and the reflectance or a reflectance for each reflecting angle read therefrom is referred to as a reflecting profile in some cases. As shown in the graph, the regular reflectance R(30) indicates a peak of the reflectance for the incident light 23 at the angle of 30 degrees, and the reflectance tends to be reduced when the angle is shifted in the regular reflecting direction. In the example of the reflecting profile shown in FIG. 7, the regular reflectance R(30) is approximately 0.094 and R(50) is approximately 0.0001%.

According to the investigations of the present inventors, in many cases in which the sufficient glare preventing effect is produced by antiglare films which are currently available on the market, that is, R(30) measured as described above is equal to or lower than 1.5%, R(50) exceeds 0.0003%. In such cases, particularly, the discoloring is found in an application to an image display apparatus with high precision. On the other hand, some antiglare films have R(30) of 1.5; or less and R(50) of 0.0003% or less. However, they do not satisfy the surface shape recited by the present invention. For this reason, the glare preventing effect is insufficient, and particularly, a dazzle is observed in the application to the image display apparatus with high precision. Consequently, the visual confirmation is deteriorated.

In order to measure the reflectance of the antiglare film, it is necessary to measure a reflectance of 0.001% or less with high precision. Therefore, it is effective to use a detector having a wide dynamic range. As such a detector, for example, it is possible to use an optical power meter or the like which is put on the market, for example. An aperture can be provided before a detector of the optical power meter to carry out a measurement by using a deformation photometer which sets an angle estimating the antiglare film to be 2 degrees. For an incident light, it is possible to use a visible ray of 380 to 780 nm. As a light source for a measurement, it is also possible to use a light emitted from a light source such as a halogen lamp which is collimated or a monochromatic light source having a high parallelism, for example, a laser or the like. In case of an antiglare film having a smooth and transparent back face, moreover, a reflection from the back face of the antiglare film influences a measured value. For example, therefore, it is preferable to cause the smooth surface of the antiglare film to optically adhere to a black acrylic resin plate by using an adhesive or a liquid such as water or glycerine, thereby measuring only a reflectance of a top surface of the antiglare film.

In the antiglare film according to the present invention, it is preferable that a dazzle should not be generated at a pixel density of an image display device with high precision to be used in a combination which is 120 ppi (pixel per inch) or less. In the case in which the dazzle is observed at a smaller pixel density of 120 ppi or less, it is hard to use the antiglare film in a combination with the image display device with high precision.

The dazzle can be evaluated by the following method.

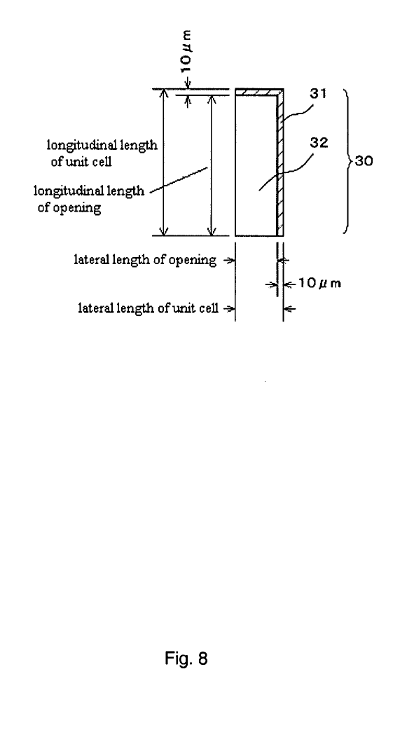

First, there is prepared a photomask having a pattern of a unit cell shown in a plan view of FIG. 8. In FIG. 8, a unit cell 30 is provided with a hook-shaped chromium shielding pattern 31 having a line width of 10 μm on a transparent substrate, and a portion in which the chromium shielding pattern 31 is not formed serves as an opening portion 32. When an evaluation is to be carried out at a pixel density of 120 ppi, it is preferable to use a photomask in which a unit cell has a dimension of 211 μm×70 μm (a length by a width in FIG. 8) and an opening portion has a dimension of 201 μm×60 μm (a length by a width in FIG. 8). A large number of unit cells shown in the drawing are arranged longitudinally and laterally to form a photomask.

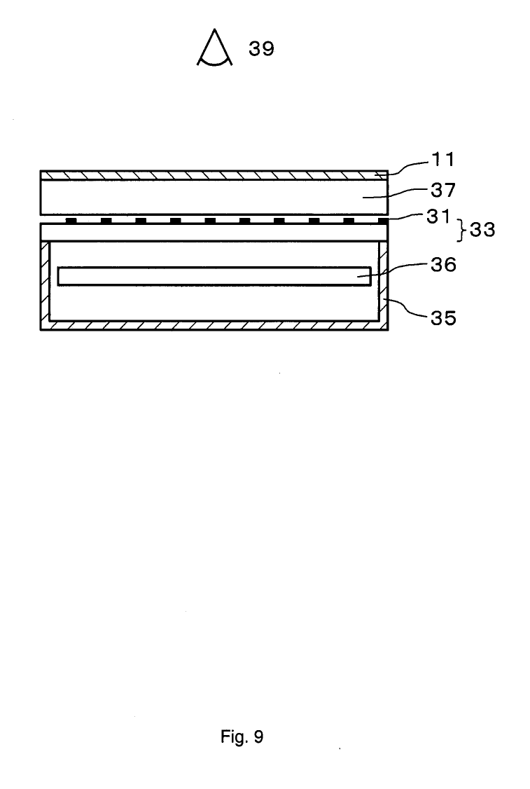

As shown in a typical sectional view of FIG. 9, the chromium shielding pattern 31 of a photomask 33 is provided on an upper side and is put on a light box 35, and a sample obtained by sticking an antiglare film 21 to a glass plate 37 through an adhesive on a flat face side thereof is put on the photomask 33. A light source 36 is disposed in the light box 35. In this state, a sensory evaluation for a dazzle is carried out through a visual observation from a place 39 apart from the sample by approximately 30 cm.

Next, description will be given to a method of manufacturing an antiglare film according to the present invention and a method of manufacturing a metal mold having a concavo-convex portion formed on a surface which serves to obtain the antiglare film. In the present invention, in order to obtain a metal mold having a concavo-convex portion, copper plating or nickel plating is carried out over a surface of a metal base material, the plated surface thereof is polished, and a particle is then hit on the polished surface to form the concavo-convex portion and the chromium plating is thereafter carried out over the concavo-convex surface.

The fine particle is hit to form the concavo-convex portion, and furthermore, the copper plating or the nickel plating is carried out over the surface of the metal base material forming a chromium plated layer. Thus, the copper plating or the nickel plating is performed over the surface of the metal constituting a metal mold so that an adhesiveness and a glossing property of the chromium plating at a subsequent step can be raised. In some cases in which the chromium plating is carried out over a surface such as iron or the concavo-convex portion is formed on the chromium plated surface by a sand blast method or a bead shot method to carry out the chromium plating again, a surface becomes easily rough so that a minute crack is generated to have a non-preferable influence on the shape of the antiglare film as described above in the background art. On the other hand, it was found that the copper plating or the nickel plating is carried out over the surface, resulting in an elimination of a drawback. The reason is that the copper plating or the nickel plating is carried out to fill in minute concavo-convex portions and nests of the metal base material and the like to form a flat and glossy surface because a coating property is high and a smoothening function is great. By these copper and nickel plating characteristics, there is eliminated a roughness of the chromium plated surface which is supposed to be caused by the minute concavo-convex portions and nests present on the metal base material. Moreover, it can be supposed that the generation of a fine crack is reduced by an enhancement in a coating property of the copper plating and the nickel plating.

Copper or nickel may be a pure metal and may be an alloy containing copper as a main substance or an alloy containing nickel as a main substance. Accordingly, the copper in the specification implies to contain copper and a copper alloy, and the nickel implies to contain nickel and a nickel alloy. Although the copper plating and the nickel plating may be carried out by electrolytic plating or nonelectrolytic plating, the electrolytic plating is usually employed.

A suitable metal for constituting a metal mold includes aluminum and iron in respect of a cost. Furthermore, it is more preferable to use aluminum having a light weight because of a convenience of handling. Aluminum and iron may also be pure metals respectively, and furthermore, may be an alloy containing aluminum or iron as a main substance. The copper plating or the nickel plating is carried out over the surface of the metal base material and the surface is further polished to obtain a smoother and glossier surface, and the particle is then hit on the surface to form fine concavo-convex portions, and, the copper plating or the nickel plating is carried out thereover to constitute a metal mold.

When the copper plating or the nickel plating is carried out, the influence of an undercoating metal is not completely eliminated if the plated layer is excessively thin. For this reason, it is preferable that a thickness should not be smaller than 10 μm. Although an upper limit of the thickness of the plated layer is not critical, approximately 500 μm or less is generally sufficient in connection with the cost.

A shape of the metal mold may be a flat metal plate or a columnar or cylindrical metal roll. If the metal mold is fabricated by using the metal roll, it is possible to manufacture the antiglare film with a continuous roll shape.

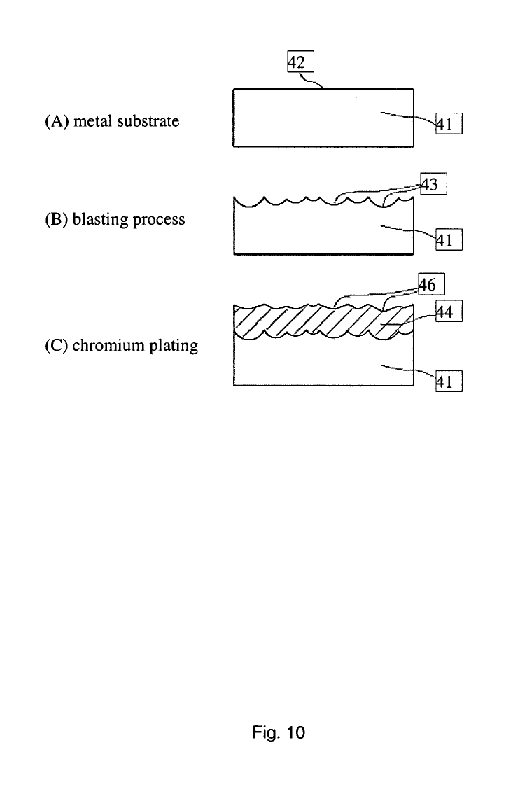

FIG. 10 is a sectional view typically showing a process for obtaining the metal mold by taking, as an example, the case in which a metal plate is used. FIG. 10(A) shows a section of a metal board 41 subjected to the copper plating or the nickel plating and the mirror polishing, and a surface thereof is formed by a polished surface 42 of the plated layer. Fine particles are hit on the metal surface subjected to the mirror polishing, thereby forming a concavo-convex portion on a surface. FIG. 10(B) is a typical sectional view showing the metal board 41 obtained after hitting the fine particles. The fine particles are hit so that a fine concave surface 43 taking a partial spherical shape is formed. Furthermore, the chromium plating is carried out over the surface having the concavo-convex portion formed by the fine particles so that the concavo-convex shape of the metal surface is caused to be dull. FIG. 10(C) is a typical sectional view showing a state brought after the chromium plating is carried out, and a chromium plated layer 44 is formed on the fine concave surface formed on the metal board 41 and a surface 46 is brought into a more dull state than the concave surface 43 of (B), that is, a state in which the concavo-convex shape is relieved by the chromium plating. Thus, the chromium plating is carried out over the fine concave surface 43 taking the partial spherical shape which is formed by hitting the fine particles on the surface of the metal so that it is possible to obtain a metal mold which substantially has no flat portion and is provided with a suitable concavo-convex portion for obtaining an antiglare film exhibiting a preferable optical characteristic.

The fine particles are hit on the metal surface formed by the copper plating or the nickel plating in such a state that the surface is polished. In particular, it is preferable that the metal surface should be polished into a close state to a mirror plane. The reason is as follows. A metal plate and a metal roll are often subjected to, for example, cutting or grinding in order to have predetermined precision. Consequently, a processed grain remains on the surface of the metal. Also in a state in which the copper plating or the nickel plating is carried out, the processed grains remain in some cases. Moreover, the surface is not completely smoothened in the plating state. In a state in which a deep processed grain or the like remains, even if the fine particles are hit to deform the metal surface, a concavo-convex portion such as the processed grain is deeper than a concavo-convex portion formed by the fine particles in some oases. The influence of the processed grain or the like is left so that an unexpected influence is given to the optical characteristic in some cases.

The method of polishing the surface plated with the metal base material has no special restriction but all of a mechanical polishing method, an electrolytic polishing method and a chemical polishing method can be used. Examples of the mechanical polishing method include a superfinishing method, wrapping, a fluid polishing method, a buff polishing method and the like. When a surface roughness after the polishing is represented as a center line average roughness Ra, Ra is preferably not greater than 1 μm, is more preferably not greater than 0.5 μm and is further preferably not greater than 0.1 μm. When Ra is excessively increased, there is a possibility that the influence of the surface roughness before a deformation might remain even if fine particles are hit to deform a metal surface, which is not preferable. Since a lower limit of Ra is not particularly restricted but has its own limitation in respect of a processing time and a processing cost, moreover, it does not need to be specified.

As a method of hitting fine particles on a surface plated with a metal base material, an injecting method is suitably used. The injecting method includes a sand blast method, a shot blast method, a liquid honing method and the like. As a particle to be used for these treatments, a shape which is close to a spherical shape is preferable to a shape having an acute angle, and a particle formed by a hard material which does not have an acute angle caused by through crushing during the treatment is preferable. As a particle to satisfy these conditions, ceramics based particles such as spherical zirconium beads and alumina beads are preferably used. For a metallic particle, moreover, beads formed of steel or stainless steel is preferable. Furthermore, it is also possible to use a particle causing a resin binder to have ceramics and metal particles.

For the particle to be hit on the surface plated with the metal base material, fine particles having an average particle diameter of 5 to 35 μm, particularly, fine particles taking a spherical shape are used. Consequently, it is possible to fabricate the antiglare film specified in the present invention which satisfies the requirements that an average length PSm in a sectional curve of a concavo-convex plane is not larger than 12 μm, a ratio Pa/Psm of an arithmetic average height Pa in the sectional curve to an average length Psm is from 0.005 to 0.012, a rage of a plane having a concavo-convex plane in an inclination angle of 2 degrees or less is not higher than 50%, and a rate of a plane having an inclination angle of 6 degrees or less is not lower than 90%. If the average particle diameter of the fine particle is smaller than 5 μm, it is hard to form a sufficient concavo-convex portion on the surface plated with the metal base material. For this reason, a sufficient antiglare function is obtained with difficulty. On the other hand, if the average particle diameter of the fine particle is greater than 35 μm, the surface concavo-convex portion becomes rough so that a dazzle is generated and a texture is deteriorated. When the processing is to be carried out by using the fine particle having an average particle diameter of 15 μm or less, it is preferable to employ a wet blast method for dispersing a particle in a proper dispersion medium to carry out the processing in such a manner that the particle is not agglutinated by a static electricity or the like.

Moreover, a pressure for hitting the fine particles and an amount of use of the fine particles are also influenced by the concavo-convex shape obtained after the processing, and furthermore, the surface shape of the antiglare film. In general, it is preferably to properly select them corresponding to a type and a particle diameter of the fine particle to be used, a type of a metal to be treated, a desirable concavo-convex shape and the like from a gauge pressure of approximately 0.07 to 0.2 MPa and an amount of the fine particle of approximately 4 to 20 g per surface area of 1 cm² of the metal.

The chromium plating is further carried out over the metal base material having the concavo-convex portions formed on the copper plated or nickel plated surface, thereby causing the concavo-convex plane to be dull to fabricate a metal plate. A condition of the dullness of the concavo-convex portion is varied depending on a type of an undercoating metal, a size and a depth of the concavo-convex portion obtained by a technique such as blast, a type and a thickness of plating and the like. For this reason, the greatest factor for controlling the condition of the dullness is the plating thickness, which is not absolutely apparent. When the thickness of the chromium plated layer is small, the effect of dulling the surface shape of the concavo-convex portion obtained by the technique such as the blast is insufficient and the optical characteristic of the antiglare film obtained by transferring the concavo-convex shape onto the transparent film is not enhanced greatly. On the other hand, when the plating thickness is excessively great, a productivity is deteriorated. The thickness of the chromium plating used in the present invention is preferably from 1 to 20 μm and is more preferably not smaller than 3 μm, and is further preferably not greater than 10 μm.

In the present invention, there is employed the chromium plating having a gloss, a high hardness and a small coefficient of friction and capable of giving an excellent mold releasing property over a surface of a metal plate, a metal roll or the like. The type of the chromium plating is not particularly restricted but it is preferable to use chromium plating for revealing an excellent gloss which is referred to as so-called glossy chromium plating, decorating chromium plating or the like. The chromium plating is usually carried out by an electrolysis and a solution containing anhydrous chromate (CrO₃) and a small amount of sulfuric acid is used for a plating bath. By regulating a current density and a time required for an electrolysis, it is possible to control the thickness of the chromium plating.

JP No. 2002-189106 A, JP2004-45472 A and JP 2004-90187 A and the like described in the background have disclosed the employment of the chromium plating. Depending on an undercoat before metal mold plating and a type of the chromium plating, a surface becomes rough after the plating and a large number of fine cracks are generated by the chromium plating in many cases. As a result, the optical characteristic of the antiglare film which is fabricated progresses in a nonpreferable direction. A metal mold having a plated surface which is rough is not suitable for the antiglare film. The reason is as follows. In order to eliminate a roughness, generally, the plated surface subjected to the chromium plating is polished. As will be described below, however, the polishing of the surface after the plating is not preferable in the present invention. In the present invention, the copper plating or the nickel plating is carried out over the undercoating metal, thereby eliminating the drawback which is easily caused by the chromium plating.

It may not be preferable that plating other than the chromium plating should be carried out over a metal surface having a concavo-convex portion. The reason is as follows. In the plating other than the chromium plating, a hardness and an abrasion resistance are reduced. Consequently, a durability of the metal mold may be deteriorated, the concavo-convex portion may be worn away in use and the metal mold may be damaged. In the antiglare film obtained by the metal mold, there is a high possibility that a sufficient antiglare function might be obtained with difficulty, and furthermore, there is also a high possibility that a defect might be generated on the film.

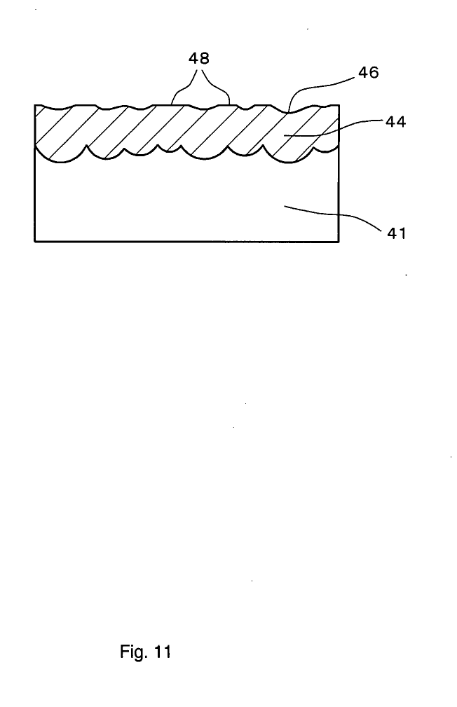

The polishing of the plated surface disclosed in JP No. 2004-90187 A is also nonpreferable in the present invention. By the execution of the polishing, a flat portion is generated on a top surface. For this reason, there is a possibility that the optical characteristic might be deteriorated, and it may not easy to carry out a shape control with a high reproducibility due to an increase in a control factor of the shape. FIG. 11 is a typical sectional view showing a metal plate on which a flat surface is generated in the case in which the chromium plating is carried out over a concavo-convex plane obtained by hitting fine particles and a dull surface thus obtained is polished, and more specifically, corresponds to a state in which a surface of a chromium plated layer 44 is polished in the state of FIG. 10(C). By the polishing, a part of convex portions in a surface concavo-convex portion 46 of the chromium plated layer 44 formed on the surface of the metal 41 is scraped to generate a flat surface 48.

Next, description will be given to a process for manufacturing an antiglare film by using the metal mold thus obtained. A shape of the metal mold obtained by the method described above is transferred onto a transparent resin film so that the antiglare film is obtained. It is preferable that the transfer of the metal mold shape onto the film should be carried out by embossing. Examples of the embossing include a UV embossing method using a photocuring resin and a hot embossing method using a thermoplastic resin.

In the UV embossing method, a photocuring resin layer is formed on a surface of a transparent base film, and is pushed against a concave-convex surface of a metal mold, and at the same time, is cured so that the concavo-convex plane of the metal mold is transferred onto the photocuring resin layer. More specifically, in a state in which an ultraviolet curing resin is coated onto the transparent base film and the coated ultraviolet curing resin is adhered to the metal mold, ultraviolet rays are irradiated from the transparent base film side to cure the ultraviolet curing resin and the transparent base film in which the ultraviolet curing resin layer obtained after the curing is formed is then peeled from the metal mold. Consequently, the shape of the metal mold is transferred onto the ultraviolet curing resin. The type of the ultraviolet curing resin is not particularly restricted. Moreover, the expression of the ultraviolet curing resin is used. By properly selecting a photo initiator, however, it is also possible to set a resin which can also be cured by a visible light having a greater wavelength than that of the ultraviolet rays. More specifically, the ultraviolet curing resin is a general name including the resin of a visible light curing type. On the other hand, in the hot embossing method, a transparent thermoplastic resin film is pushed against a metal mold in a heating state and a surface shape of the metal mold is transferred onto the thermoplastic resin film. In these embossing methods, a UV embossing method is preferable in respect of a productivity.

It is preferable that a transparent base film which can be used for fabricating the antiglare film should be substantially and optically transparent, and an example of a resin film includes a triacetylcellulose film, a polyethylene terephthalate film or the like.

It is possible to use an ultraviolet curing resin which is available on the market. For example, multifunctional acrylates such as trimethylolpropane triacrylate and pentaerythritol tetraacrylate are used singly or at least two of them are mixed and used, and they are mixed with a photopolymerizing initiator such as “IRGACURE-907” and “IRGACURE-184” (manufactured by Ciba Specialty Chemicals Co., Ltd.) or (LUCILIN TPO) (manufactured by BASF Co., Ltd.) and a mixture thus obtained can be an ultraviolet curing resin.

The thermoplastic transparent resin film to be used for the hot embossing method may be any substantially transparent film. Example may include a solvent cast film, an extruded film or the like of a thermoplastic resin such as polymethymethacrylate, polycarbonate, polyethylene terephthalate, triacetylcellulose, or amorphous cyclic polyolefin containing a norbornen based compound. These transparent resin films can also be transparent base films in the case in which the UV embossing method described above is employed.

In the antiglare film according to the present invention which is constituted as described above, an excellent antiglare effect can be obtained and discoloring can also be prevented effectively. When the antiglare film is attached to an image display apparatus, therefore, an excellent visual confirmation can be obtained. In the case in which the image display apparatus is a liquid crystal display, the antiglare film can be laminated on a polarizing film. More specifically, many polarizing films generally have such a structure that a protecting film is laminated on at least one of surfaces of a polarizer formed by a polyvinyl alcohol based resin film in which iodine or a dichroic dye is adsorbed and oriented. By sticking the antiglare film having the concavo-convex portion given to one of surfaces of the polarizing film, it is possible to obtain an antiglare polarizing film. Moreover, the antiglare film having the concavo-convex portion described above is used as both a protecting film and an antiglare layer. By sticking the film to either side of the polarizer in such a manner that a concavo-convex plane is provided externally, similarly, it is possible to obtain an antiglare polarizing film. In the polarizing film in which the protecting film is laminated, furthermore, it is possible to obtain the antiglare polarizing film by giving the antiglare concavo-convex portion to the surface of the protecting film on either side.

The image display apparatus according to the present invention is obtained by combining the antiglare film having the specific surface shape described above with image display means. The image display means includes a liquid crystal cell enclosing a liquid crystal between upper and lower boards, and is represented by a liquid crystal panel for changing an orientation state of a liquid crystal by an application of a voltage, thereby displaying an image. In addition, the antiglare film according to the present invention can also be applied to various well-known displays, for example, a plasma display panel, a CRT display, an organic EL display and the like. By disposing the antiglare film on the visual confirmation side of the image display means, the image display apparatus is constituted. In this case, the concavo-convex plane of the antiglare film is disposed on an outside (the visual confirmation side). The antiglare film may be directly stuck to a surface of the image display means. In the case in which the liquid crystal panel is set to be the image display means, it is also possible to stick the antiglare film to a surface of the liquid crystal panel through the polarizing film as described above, for example. Thus, the image display apparatus comprising the antiglare film according to the present invention can scatter an incident light through the concavo-convex portion of the surface provided in the antiglare film, thereby blurring a projected image. Consequently, an excellent visual confirmation can be given.

Also in the case in which the antiglare film according to the present invention is applied to an image display apparatus with high precision, moreover, it has a performance such as a low haze, a sufficient prevention of a glare, a prevention of discoloring and a suppression of a dazzle without generating the dazzle observed in the conventional antiglare film.

### EXAMPLES

Examples will be described below, and the present invention will be described in more detail. The present invention is not restricted to these examples. A method of evaluating an antiglare film in the examples is as follows.

(Measurement of Average Length PSm in Sectional Curve and Arithmetic Average Height Pa)

By using a confocal microscope “PLμ2300” manufactured by Sensofar Co., Ltd., the surface shape of the antiglare film was measured. In this case, an optically transparent adhesive was used to stick the antiglare film to a glass board in such a manner that the concavo-convex plane is a surface in order to prevent a warpage of a sample and the measurement was thus carried out. In the measurement, a magnification of an objective lens was set to be 50. Based on the measurement data, a calculation was carried out by a method in accordance with JIS B 0601 to obtain an average length PSm and an arithmetic average height Pa.

(Measurement of Inclination Angle of Concavo-convex Plane)

By using the same confocal microscope “PLμ2300” as described above, the surface shape of the antiglare film was measured. Also in this case, an optically transparent adhesive was used to stick the antiglare film to a glass board in such a manner that the concavo-convex plane is a surface in order to prevent a warpage of a sample and the measurement was thus carried out. In the measurement, a magnification of an objective lens was set to be 50. Based on the measurement data, a calculation was carried out on the basis of the algorithm and a histogram for an inclination angle of the concavo-convex plane was created to obtain a distribution for each inclination angle therefrom.

(Measurement of Voronoi Polygon Average Area in Voronoi Division)

By using the same confocal microscope “PLμ2300” as described above, the surface shape of the antiglare film was measured. Also in this case, an optically transparent adhesive was used to stick the antiglare film to a glass board in such a manner that the concavo-convex plane is a surface in order to prevent a warpage of a sample and the measurement was thus carried out. In the measurement, a magnification of an objective lens was set to be 50. Based on the measurement data, a calculation was carried out on the basis of the algorithm to obtain an average area of a voronoi polygon.

(Measurement of Haze)

By using a haze meter “HM-150” type manufactured by MURAKAMI COLOR RESEARCH LABORATORY CO., LTD. in accordance with JIS K 7136, a haze of an antiglare film was measured. Also in this case, an optically transparent adhesive was used to stick the antiglare film to a glass board in such a manner that the concavo-convex plane is a surface in order to prevent a warpage of a sample and the measurement was thus carried out.

(Measurement of Reflection Visibility)

By using a mapping measuring device “ICM-1DP” manufactured by SUGA TEST INSTRUMENTS CO., LTD. in accordance with JIS K 7105, a reflection visibility of the antiglare film was measured. Also in this case, an optically transparent adhesive was used to stick the antiglare film to a glass board in such a manner that the concavo-convex plane is a surface in order to prevent a warpage of a sample and the measurement was thus carried out. In order to prevent a reflection from a back surface of the glass, moreover, a black acrylic resin plate having a thickness of 2 mm was adhered and stuck to a glass face of the glass plate having the antiglare film stuck thereto through water and a light was incident from the sample (the antiglare film) side in this state to carry out the measurement. A measured value is a total of values measured by using the three types of optical combs having widths between dark and bright portions which are 0.5 mm, 1.0 mm and 2.0 mm respectively as described above.

(Measurement of Transmission Visibility)

By using the same mapping measuring device “ICM-1DP” as described above, a transmission visibility of the antiglare film was measured. Also in this case, an optically transparent adhesive was used to stick the antiglare film to a glass board in such a manner that the concavo-convex plane is a surface in order to prevent a warpage of a sample and the measurement was thus carried out. In this state, a light was incident from the glass side to carry out the measurement. A measured value is a total of values measured by using four types of optical combs having widths between dark and bright portions which are 0.125 mm, 0.5 mm, 1.0 mm and 2.0 mm, respectively. In this case, a maximum value of the transmission visibility is 400%.

(Measurement of Reflectance)

A parallel light was irradiated from an He—Ne laser onto the concavo-convex plane of the antiglare film in a direction of an inclination at 30 degrees with respect to a film normal to measure a change in an angle of a reflectance in a plane including the film normal and a direction of the irradiation. For the measurement of the reflectance, “3292 03 Optical Power Sensor” and “3292 Optical Power Meter” manufactured by Yokogawa Electric Corporation were used for measuring the reflectance.

(Visual Evaluation of Glare and Discoloring)

In order to prevent the reflection from the back face of the antiglare film, the antiglare film was stuck to a black acrylic resin plate in such a manner that a concavo-convex plane is a surface, and a visual observation from the concavo-convex plane side was carried out in a bright room having a fluorescent lamp to visually evaluate the presence of a glare of the fluorescent lamp and a degree of discoloring. Both the glare and the discoloring were evaluated based on the following reference in three stages of 1 to 3.

Glare

1. The glare is not observed.
2. The glare is observed slightly.
3. The glare is observed clearly.
   Discoloring
1. The discoloring is not observed.
2. The discoloring is observed slightly.
3. The discoloring is observed clearly.
   (Evaluation of Dazzle)

A dazzle was evaluated by the method described with reference to FIGS. 8 and 9. More specifically, the photomask having the pattern of the unit cell shown in FIG. 8 was fabricated and was put on the light box 35 with the chromium shielding pattern 31 of the photomask 33 provided on an upper side as shown in FIG. 9, and the sample in which the antiglare film 21 is stuck to the glass plate 37 having a thickness of 1.1 mm with an adhesive having a thickness of 20 μm was put on the photomask 33 and was visually observed from the place 39 apart from the sample by approximately 30 cm, thereby performing a sensory evaluation in seven stages over a degree of the dazzle. A level 1 corresponds to a state in which the dazzle is not observed at all, a level 7 corresponds to a state in which the dazzle is observed considerably and a level 3 corresponds to a state in which the dazzle is observed very slightly. In the unit cell of the photomask which was used, a length of the unit cell by a width of the unit cell in FIG. 8 was 211 μm×70 μm, and accordingly, a length of an opening portion by a width of the opening portion was 201 μm×60 μm in the drawings.

### Example 1

There was prepared a surface of an aluminum roll having a diameter of 200 mm (A5056 based on JIS) subjected to copper ballard plating. The copper ballard plating was constituted by a copper plated layer/a thin silver plated layer/a surface copper plated layer, and the whole plated layer had a thickness of approximately 200 μm. The copper plated surface was mirror polished, and furthermore, zirconium beads “TZ-SX-17” manufactured by Tosoh Corporation (trade name, an average particle diameter of 20 μm) were blasted onto the polished surface at a blast pressure of 0.1 MPa (a gauge pressure and so forth) in an amount of used beads of 8 g/cm¹ (an amount of use per surface of the roll of 1 cm² and so forth) by using a blasting apparatus (manufactured by FUJI MANUFACTURING CO., LTD.) to form a concavo-convex portion on the surface. Chromium plating was carried out over the copper plated aluminum roll having the concavo-convex portion thus obtained, and a metal mold was thus fabricated. At this time, a chromium plating thickness was set to be 6 μm.

In addition, a photocuring resin composition “GRANDIC 806T” (trade name) manufactured by DAINIPPON INK AND CHEMICALS, INCORPORATED was dissolved in ethyl acetate to prepare a solution having a concentration of 50% by weight, and furthermore, “LUCILIN TPO” (manufactured by BASF, chemical name: 2, 4, 6—trimethybenzoyl diphenylphosphine oxide) to be a photopolymerizlng initiator was added in an amount of 5 parts by weight for 100 parts by weight of a curing resin component so that a coating solution was prepared. A triacetylcellulose (TAC) film having a thickness of 80 μm was coated with the coating solution to have a coating thickness of 5 μm after drying, and the drying was carried out for three minutes in a drying machine set at 60° C. The film obtained after the drying was pushed against and adhered to the concavo-convex plane of the metal mold which was fabricated by means of a rubber roll in such a manner that a photocuring resin composition layer is provided on the metal mold side. In this state, a light emitted from a high pressure mercury lamp having an Intensity of 20 mW/cm² was irradiated in an h ray converted light amount of 200 mW/cm² from the TAC film side to cure the photocuring resin composition layer. Then, the TAC film was peeled together with the curing resin from the metal mold so that a transparent antiglare film having the concavo-convex portion on a surface and constituted by a laminated product of the curing resin and the TAC film was obtained.

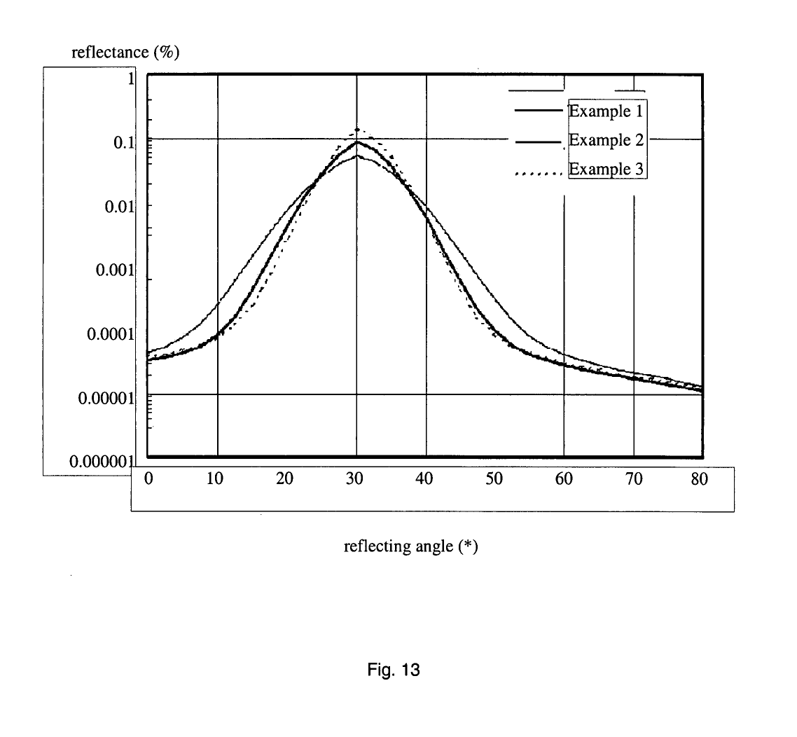

Referring to the antiglare film thus obtained, a concavo-convex surface shape, an optical characteristic and an antiglare performance were evaluated by the technique described above, and a result is shown in Table 1 together with the condition for fabricating the metal mold. Moreover, FIG. 12 shows a histogram of an inclination angle in the concavo-convex plane of the antiglare film and FIG. 13 shows a scattering characteristic of a reflected light obtained in a measurement of a reflectance (a graph of a reflecting profile). The details of a reflection visibility and a transmission visibility in Table 1(B) are as follows.

| | reflection | transmission |
|---|---|---|
| | visibility | visibility |
| 0.125 mm optical comb | — | 78.7% |
| 0.5 mm optical comb | 5.8% | 78.7% |
| 1.0 mm optical comb | 8.3% | 78.8% |
| 2.0 mm optical comb | 12.9% | 79.7% |
| Total | 27.0% | 315.9% |

### Examples 2 and 3 and Comparative Examples 1 and 21

A metal mold having a concavo-convex portion on a surface was fabricated in the same manner as in the example 1 except that the condition for fabricating a metal mold was changed as shown in the Table 1. The respective metal molds were used to fabricate a transparent antiglare film having a concavo-convex portion on a surface and constituted by a laminated product of a curing resin and a TAC film in the same manner as in the example 1. A surface shape, an optical characteristic and an antiglare performance of the antiglare film thus obtained are shown in the Table 1 together with the condition for fabricating a metal mold. In the Table 1, (A) illustrates the condition for fabricating a metal mold and the surface shape of the antiglare film and (B) illustrates the optical characteristic and the antiglare performance of the antiglare film. In the Table, “>99.5%” in a column of an inclination angle “≦6°” implies that a rate of a plane having an inclination angle of 6 degrees or less is higher than 99.5% and has a value approximating to 100%.

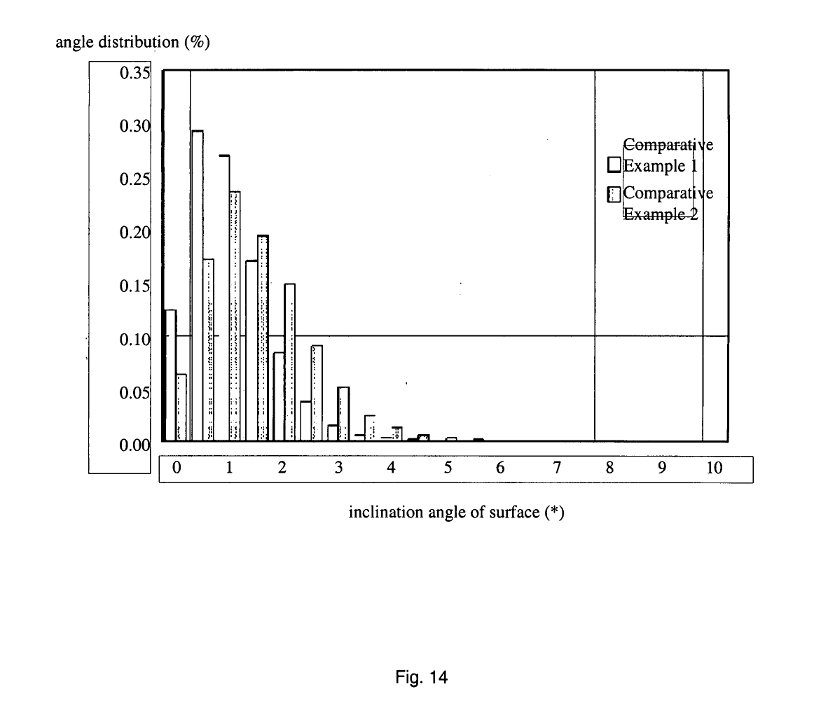

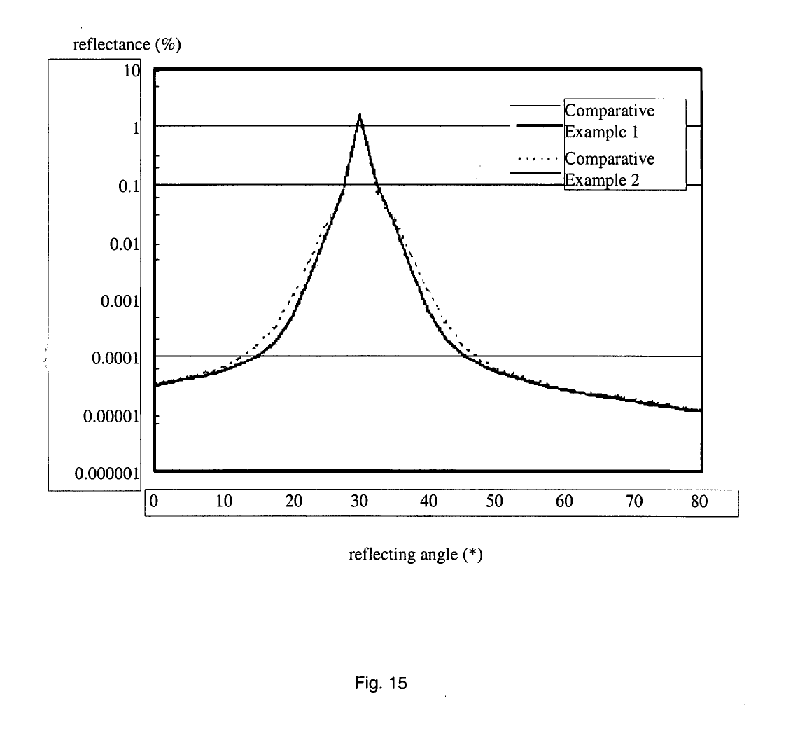

Referring to examples 2 and 3, moreover, FIG. 12 shows a histogram of an inclination angle in a concavo-convex plane of the antiglare film together with the result of the example 1 and FIG. 13 is a graph showing a reflecting profile together with the result of the example 1. On the other hand, referring to comparative examples 1 and 2, FIG. 14 shows a histogram of an inclination angle in a concavo-convex plane of the antiglare film and FIG. 15 is a graph showing a reflecting profile.

TABLE 1
(A) Metal mold fabricating condition and surface shape of antiglare film

| | Metal mold fabricating | | | Surface shape of antiglare film | | | | | |
|---|---|---|---|---|---|---|---|---|---|
| | condition | | | | | | Inclination | | Average area |
| | Amount of | Blast | Plating | | | | angle | | of voronoi |
| Sample No. | blast | pressure | thickness | PSm | Pa | Pa/PSm | ≦2° | ≦6° | polygon |
| Example 1 | 5 g/cm² | 0.1 MPa | 6 μm | 10.11 μm | 0.099 μm | 0.010 | 32% | 95% | 135 μm² |
| Example 2 | 9 g/cm² | 0.1 MPa | 3 μm | 8.24 μm | 0.095 μm | 0.012 | 26% | 91% | 103 μm² |
| Example 3 | 8 g/cm² | 0.1 MPa | 8 μm | 11.71 μm | 0.083 μm | 0.007 | 50% | >99.5% | 192 μm² |
| Comparative | 8 g/cm² | 0.05 MPa | 6 μm | 9.18 μm | 0.041 μm | 0.004 | 85% | >99.5% | 114 μm² |
| example 1 | | | | | | | | | |
| Comparative | 5 g/cm² | 0.05 MPa | 3 μm | 7.69 μm | 0.041 μm | 0.005 | 66% | >99.5% | 101 μm² |
| example 2 | | | | | | | | | |

(B) Optical characteristic and antiglare performance of antiglare film

| | Optical characteristic | | | | | | | |
|---|---|---|---|---|---|---|---|---|
| | | Reflection | Transmission | Reflecting profile | | Antiglare performance | | |
| Sample No. | Haze | visibility | visibility | R (30) | R (50) | Glare | Discoloring | Dazzle |
| Example 1 | 6.0% | 27.0% | 315.9% | 0.09% | 0.00010% | 1 | 1 | 3 |
| Example 2 | 10.6% | 25.5% | 307.4% | 0.05% | 0.00027% | 1 | 1 | 3 |
| Example 3 | 4.0% | 75.3% | 323.6% | 0.15% | 0.00009% | 1 | 1 | 2 |
| Comparative | 1.5% | 159.3% | 378.5% | 1.58% | 0.00005% | 3 | 1 | 2 |
| example 1 | | | | | | | | |
| Comparative | 2.6% | 174.7% | 382.5% | 1.41% | 0.00006% | 3 | 1 | 2 |
| example 2 | | | | | | | | |

As shown in the Table 1, a rate of a plane having a concavo-convex surface in an inclination angle of 2 degrees or less is 85% in the comparative example 1 and a rate of a plane having a concavo-convex surface in an inclination angle of 2 degrees or less is 66% in the comparative example 2. In both of them, a large number of planes have small inclination angles. The following reason can be supposed. The blast pressure for a metal roll is reduced to 0.05 MPa so that a sufficient number of concavo-convex portions are not formed. A large number of flat surfaces are also present in the concavo-convex surface of the antiglare film obtained as a result. Thus, the samples according to the comparative examples 1 and 2 in which a large number of planes having the small inclination angles are present had a glare and did not exhibit a sufficient antiglare performance.

On the other hand, in the samples according to the examples 1 to 3 in which the surface shape including a surface roughness and an inclination angle distribution of a surface satisfy the regulations of the present invention, the glare was not observed, the discoloring was not generated, the dazzle was rarely observed and an excellent antiglare performance was exhibited.

### Comparative Example 3

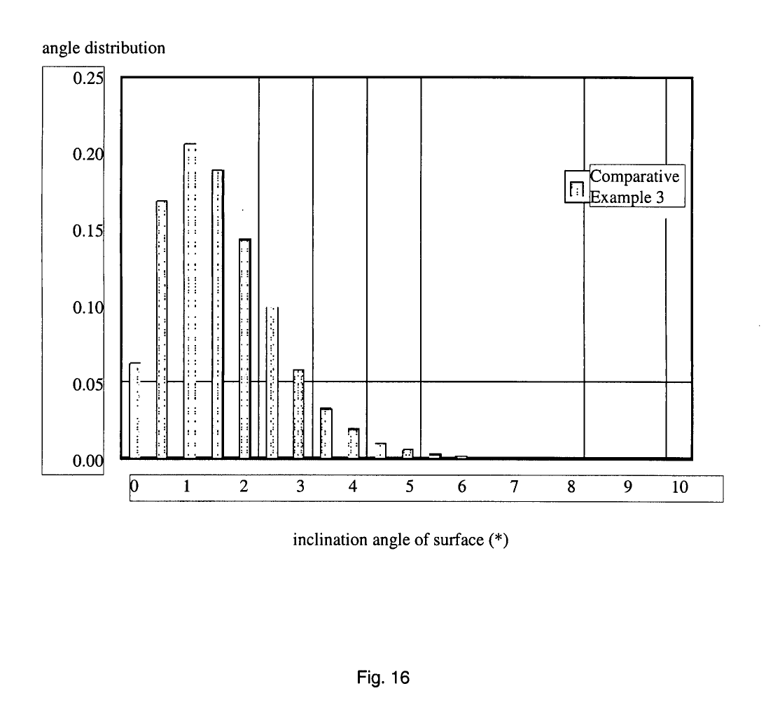

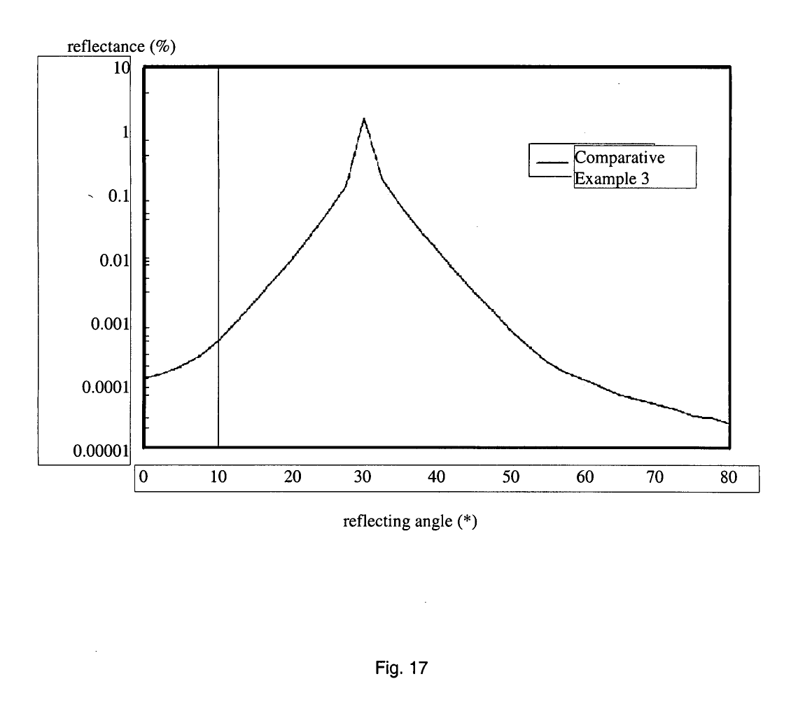

There was prepared a steel tube roll (STKM 13A based on JIS) having a diameter of 200 mm which has a surface subjected to chromium plating in a thickness of approximately 100 μm. The chromium plated surface was mirror polished, and furthermore, the same zirconium beads TZ-SX-17 as used in the example 1 was blasted onto the polished surface at a blast pressure of 0.2 MPa and an amount of the used beads of 8 g/cm² so that a concavo-convex portion was given to the surface. The chromium plating was carried out again over the mirror polished chromium plated steel tube roll having the concavo-convex portion thus obtained, and a metal mold was thus fabricated. A thickness of the Chromium plated layer on a top surface was set to be 2 μm. By using the metal mold, a transparent antiglare film having a concavo-convex portion on a surface and constituted by a laminated product of a curing resin and a TAC film was fabricated in the same manner as in the example 1. A surface shape, an optical characteristic and an antiglare performance of the antiglare film thus obtained are shown in Table 2. In the Table 2, (A) illustrates the surface shape of the antiglare film and (B) illustrates the optical characteristic and the antiglare performance of the antiglare film. Moreover, FIG. 16 shows a histogram of an Inclination angle on a concavo-convex plane of the antiglare film thus obtained and FIG. 17 is a graph showing a reflecting profile.

TABLE 2
(A) Surface shape of antiglare film

Surface shape

| | |
|---|---|
| Inclination | Average area |
| angle | of voronoi |

| Sample No. | PSm | Pa | Pa/PSm | ≦2° | ≦6° | polygon |
|---|---|---|---|---|---|---|
| Comparative | 5.86 μm | 0.044 μm | 0.007 | 62% | 99% | 75 μm² |
| example 3 | | | | | | |

(B) Optical characteristic and antiglare performance of antiglare film

| | Optical characteristic | | | | | | | |
|---|---|---|---|---|---|---|---|---|
| | | Reflection | Transmission | Reflecting profile | | Antiglare performance | | |
| Sample No. | Haze | visibility | visibility | R (30) | R (50) | Glare | Discoloring | Dazzle |
| Comparative | 5.1% | 155.0% | 350.4% | 1.57% | 0.00074% | 3 | 2 | 2 |
| example 3 | | | | | | | | |

As shown in the Table 2, in the antiglare film according to the comparative example 3, a rate of a plane having an inclination angle of 2 degrees or less reached 62%, and the glare was observed clearly and discoloring was slightly seen. Thus, a sufficient antiglare property was not exhibited. It can be supposed that the glare is observed because the chromium plating is hard before hitting fine particles and a sufficient concavo-convex portion cannot be formed. Moreover, the reason why the discoloring is seen irrespective of an insufficient glare preventing effect is supposed as follows. A fine crack was generated on the antiglare surface by the chromium plating at a final step.

### Comparative Example 41

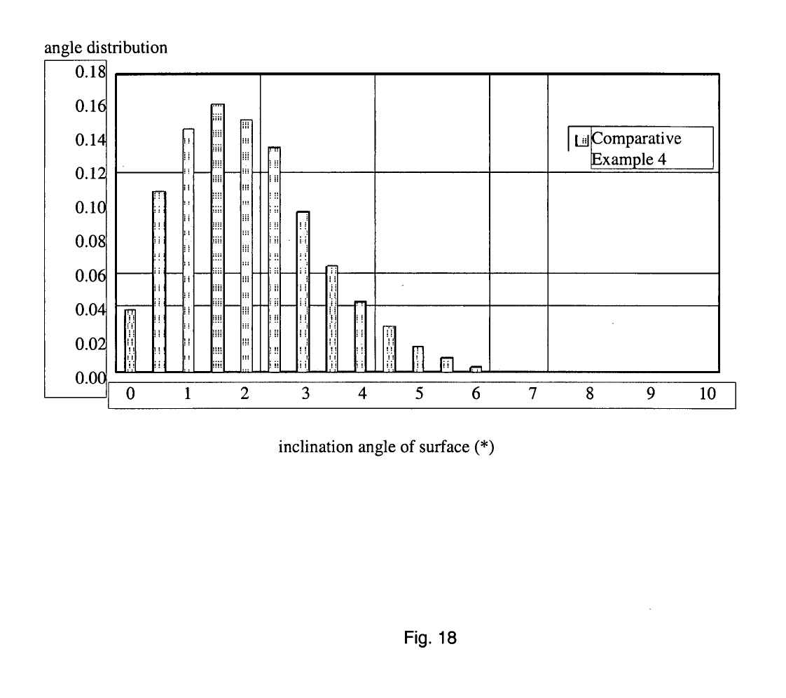

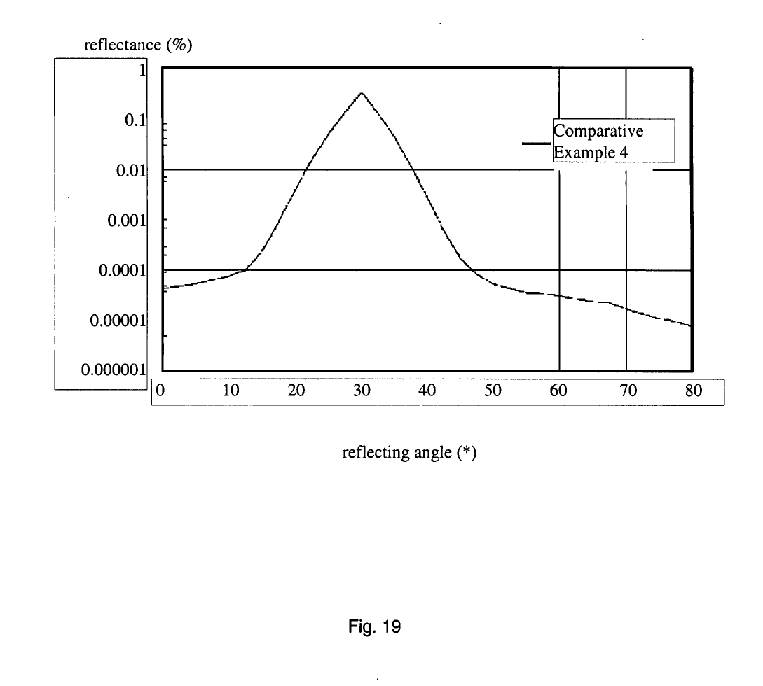

A surface of an aluminum roll (A5056 based on JIS) having a diameter of 300 mm was mirror polished. The same zirconium beads “TZ-SX-17” as used in the example 1 was blasted onto the surface of the mirror polished aluminum roll thus obtained at a blast pressure of 0.1 MPa in an amount of the used beads of 8 g/cm² and a concavo-convex portion was thus provided on the surface. The aluminum roll having the concavo-convex portion thus obtained was subjected to nonelectrolytic glossy nickel plating to fabricate a metal mold. A plating thickness was set to be 15 μm. By using the metal mold, a transparent antiglare film having a concavo-convex portion on a surface and constituted by a laminated product of a curing resin and a TAC film was fabricated in the same manner as in the example 1. Table 3 shows a concavo-convex surface shape, an optical characteristic and an antiglare performance of the antiglare film thus obtained. In the Table 3, (A) illustrates the surface shape of the antiglare film and (B) illustrates the optical characteristic and the antiglare performance of the antiglare film. In the Table, the meaning of “>99.5%” in a column of an inclination angle “≦6°” is the same as that in the Table 1. Moreover, FIG. 18 shows a histogram of an inclination angle in the concavo-convex plane of the antiglare film and FIG. 19 is a graph showing a reflecting profile.

TABLE 3
(A) Surface shape of antiglare film

Surface shape

| | |
|---|---|
| Inclination | Average area |
| angle | of voronoi |

| Sample No. | PSm | Pa | Pa/PSm | ≦2° | ≦6° | polygon |
|---|---|---|---|---|---|---|
| Comparative | 15.29 μm | 0.131 μm | 0.009 | 46% | >99.5% | 370 μm² |
| example 4 | | | | | | |

(B) Optical characteristic and antiglare performance of antiglare film

| | Optical characteristic | | | | | | | |
|---|---|---|---|---|---|---|---|---|
| | | Reflection | Transmission | Reflecting profile | | Antiglare performance | | |
| Sample No. | Haze | visibility | visibility | R (30) | R (50) | Glare | Discoloring | Dazzle |
| Comparative | 3.4% | 21.1% | 110.0% | 0.32% | 0.00005% | 1 | 1 | 4 |
| example 4 | | | | | | | | |

As shown in the Table 3, the antiglare film according to the comparative example 4 reached a sufficient prevention of a glare and a suppression of discoloring. Since an average length PSm in a sectional curve of the concavo-convex surface exceeded 12 μm, however, a dazzle was slightly observed.

### Comparative Examples 5 to 10

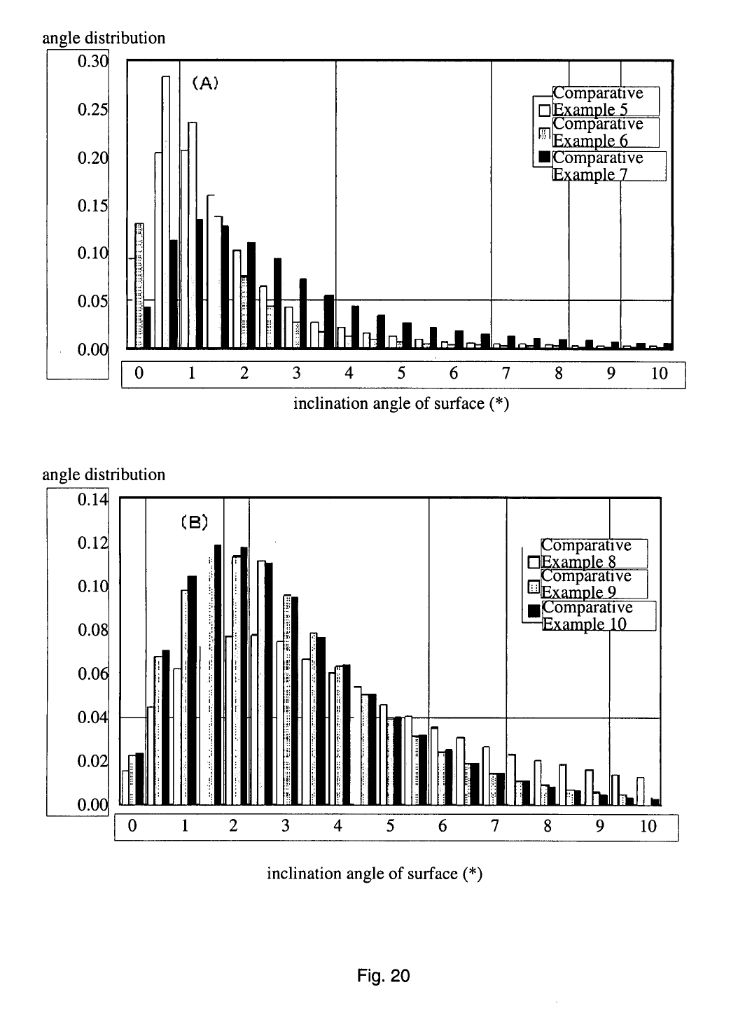

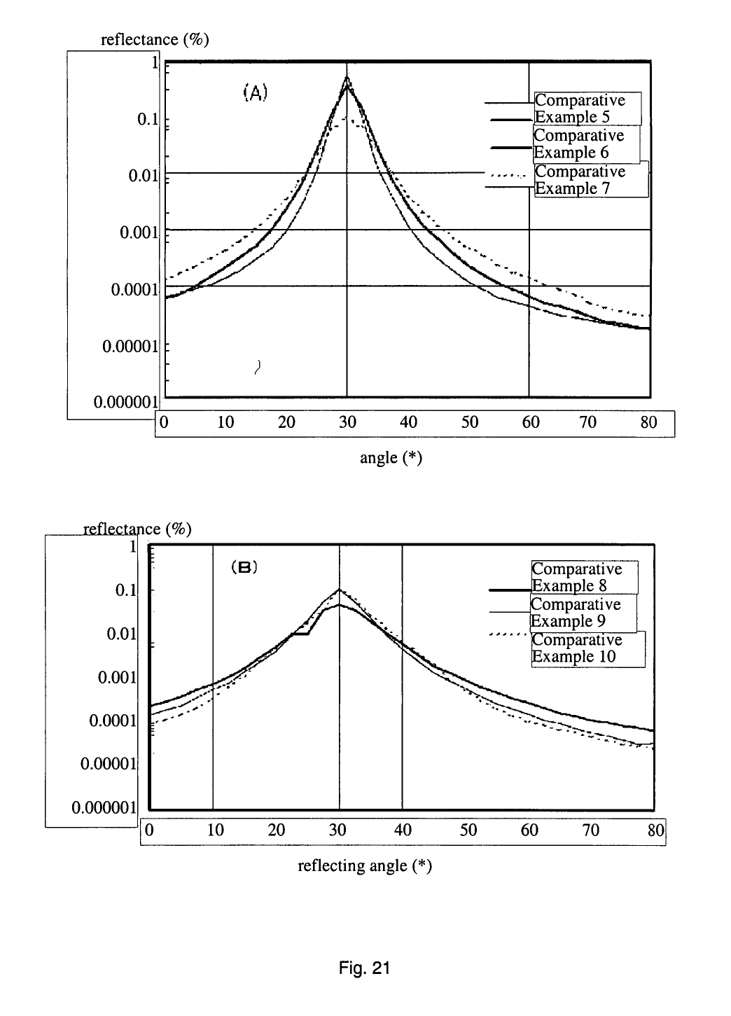

Referring to antiglare films “AG1”, “AG3”, “AG5”, “AG6”, “AG8” and “GL6” (according to comparative examples 5 to 10) used as antiglare layers in a polarizing plate “Sumikaran” sold by SUMITOMO CHEMICAL CO., LTD. and having a filler dispersed in an ultraviolet curing resin, respective surface shapes, optical characteristics and antiglare performances were evaluated by the technique described above. The result is shown in Tale 4. In the Table 4, (A) illustrates the surface shape of the antiglare film and (B) illustrates the optical characteristic and the antiglare performance of the antiglare film. Moreover, FIG. 20 shows a histogram of an inclination angle in a concavo-convex plane of each of the antiglare films and FIG. 21 is a graph showing a reflecting profile. In FIGS. 20 and 21, (A) shows the results obtained in the comparative examples 5 to 7 and (B) shows the results obtained in the comparative examples a to 10.

TABLE 4
(A) Surface shape of antiglare film

Surface shape

| | |
|---|---|
| Inclination | Average area |
| angle | of voronoi |

| Sample No. | PSm | Pa | Pa/PSm | ≦2° | ≦6° | polygon |
|---|---|---|---|---|---|---|
| Comparative | 31.91 μm | 0.154 μm | 0.006 | 66% | 96% | 2.084 μm² |
| example 5 | | | | | | |
| Comparative | 45.04 μm | 0.220 μm | 0.005 | 78% | 98% | 1.762 μm² |
| example 6 | | | | | | |
| Comparative | 20.21 μm | 0.190 μm | 0.009 | 41% | 87% | 546 μm² |
| example 7 | | | | | | |
| Comparative | 25.90 μm | 0.284 μm | 0.011 | 19% | 69% | 354 μm² |
| example 8 | | | | | | |
| Comparative | 15.67 μm | 0.157 μm | 0.009 | 30% | 88% | 345 μm² |
| example 9 | | | | | | |
| Comparative | 17.23 μm | 0.196 μm | 0.011 | 32% | 90% | 297 μm² |
| example 10 | | | | | | |

(B) Optical characteristic and antiglare performance of antiglare film

| | Optical characteristic | | | | | | | |
|---|---|---|---|---|---|---|---|---|
| | | Reflection | Transmission | Reflecting profile | | Antiglare performance | | |
| Sample No. | Haze | visibility | visibility | R (30) | R (50) | Glare | Discoloring | Dazzle |
| Comparative | 3.6% | 15.7% | 52.1% | 0.37% | 0.00023% | 1 | 1 | 5 |
| example 5 | | | | | | | | |
| Comparative | 3.4% | 20.1% | 97.1% | 0.57% | 0.00012% | 2 | 1 | 6 |
| example 6 | | | | | | | | |
| Comparative | 10.7% | 23.2% | 65.9% | 0.10% | 0.00048% | 1 | 2 | 3 |
| example 7 | | | | | | | | |
| Comparative | 20.1% | 21.7% | 40.9% | 0.04% | 0.00086% | 1 | 3 | 5 |
| example 8 | | | | | | | | |
| Comparative | 10.9% | 30.3% | 199.8% | 0.10% | 0.00055% | 1 | 2 | 4 |
| example 9 | | | | | | | | |
| Comparative | 36.6% | 15.5% | 58.2% | 0.10% | 0.00053% | 1 | 3 | 3 |
| example 10 | | | | | | | | |

As a result, there is no antiglare film having all of the low haze, the sufficient prevention of a glare, the prevention of discoloring and the prevention of a dazzle. In the antiglare films according to the comparative examples 5 and 6, the dazzle is remarkable because an average length PSm in a sectional curve of the concavo-convex surface is considerably greater than 12 μm, and furthermore, the surface concavo-convex portion becomes flat because a rate of a plane having an inclination angle of 2 degrees or less is higher than 50%. In the comparative example 6 in which the rate is high, that is, 78%, particularly, the glare preventing effect is not sufficient. On the other hand, in the antiglare films according to the comparative examples 7 to 10, the rate of the plane having an inclination angle of 2 degrees or less is low. Although they have the sufficient glare preventing effect, therefore, there is a great tendency that the discoloring is generated together with the main fact that a rate of a plane having an inclination angle of 6 degrees or less is lower than 90% (the comparative examples 7 to 9) or is almost 90% (the comparative example 10) and a reflectance R(50) in a direction having a reflecting angle of 50 degrees with respect to a 30-degree incident light is higher than 0.0003% (in all).

From the above results, it is apparent that it is necessary provide the requirements recited in the present invention balance in order to achieve the optical characteristic to the object of the present invention.

The antiglare film according to the present invention is disposed on a visual confirmation side of an image display device with respect to various displays such as a liquid crystal panel, a plasma display panel, a CRT display and an organic EL display. Consequently, it is possible to blur a projected image and to give an excellent visual confirmation without generating discoloring and a dazzle.

The antiglare film according to the present invention can be used for an image display apparatus by a combination with image display means such as a liquid crystal display device and a plasma display panel. Therefore, the image display apparatus according to the present invention comprises the antiglare film and the image display means, and the antiglare film is disposed on a visual confirmation side of the image display means.

The antiglare film according to the present invention has a low haze and maintains a brightness of a display image, and at the same time, is excellent in an antiglare performance such as a prevention of a glare and that of a reflection, a suppression of discoloring and the prevention of the generation of a dazzle According to the method of the present invention, moreover, the antiglare film can be manufactured industrially and advantageously. The image display apparatus in which the antiglare film according to the present invention is disposed is excellent in a brightness, an antiglare performance and a visual confirmation.

What is claimed is:

1. An antiglare film having a fine concavo-convex portion formed on a transparent base material,
wherein an average length PSm in an optional sectional curve of the concavo-convex surface is not greater than 12 μm,
a ratio Pa/PSm of an arithmetic average height Pa in the sectional curve to the average length PSm is from 0.005 to 0.012,
a rate of a plane having the concavo-convex surface in an inclination angle of 2 degrees or less is not higher than 50%, and
a rate of a plane having the concavo-convex surface in an inclination angle of 6 degrees or less is not lower than 90%.

2. The antiglare film according to claim 1, wherein an antiglare layer free from a fine particle.

3. The antiglare film according to claim 1, wherein an average area of a polygon formed when an apex of a convex portion of the concavo-convex surface is set to be a generating point and the surface is voronoi divided is from 100 m² to 200 μM².

4. The antiglare film according to any of claim 1, wherein a haze is not higher than 12%.
a total of reflection visibilities measured at a light incident angle of 45 degrees by using three types of optical combs having widths between dark and bright portions of 0.5 mm, 1.0 mm and 2.0 mm is not greater than 50%, and
with respect to a light incident at an incident angle of 30 degrees, a reflectance R(30) of a reflecting angle of 30 degrees is from 0.05% to 1.5% and a reflectance R(50) of a reflecting angle of 50 degrees is from 0.00001% to 0.0003%.

5. A method of manufacturing an antiglare film comprising:
carrying out copper plating or nickel plating over a surface of a metal;
polishing the plated surface;
hitting a fine particle onto the polished surface to form a concavo-convex portion;
carrying out chromium plating over the concavo-convex surface to form a metal mold;
transferring the concavo-convex surface of the metal mold onto a transparent resin film; and
peeling, from the metal mold, the transparent resin film having the concavo-convex surface transferred thereto.

6. The method according to claim 5, wherein the chromium plated surface is free from polish treatment.

7. The method according to claim 5 or 6, wherein a chromium plating thickness is from 1 μm to 20 μm.

8. The method according to claim 5 or 6, wherein a chromium plating thickness is from 3 μm to 20 μm.

9. A method of manufacturing a metal mold for fabricating an antiglare film, comprising:
carrying out copper plating or nickel plating over a surface of a metal:
polishing the plated surface;
hitting a fine particle onto the polished surface to form a concavo-convex portion; and
carrying out chromium plating over the concavo-convex surface.

10. An image display apparatus comprising the antiglare film according to any of claims 1 to 4 and image display means, the antiglare film being disposed on a visual confirmation side of the image display means.
